(19) United States
(12) Patent Application Publication
(10) Pub. No.: US 2024/0065175 A1
(43) Pub. Date: Feb. 29, 2024

(54) DUAL ARM MECHANICAL PRUNING APPARATUSES AND RELATED METHODS

(71) Applicant: Preferred Growers Solutions, LLC, Clovis, CA (US)

(72) Inventors: Brendan J. Brooks, Clovis, CA (US); Carlos A MENDEZ, Exeter, CA (US); Allen HAYES, Yuba City, CA (US); Alan ISSACSON, Yuba City, CA (US)

(21) Appl. No.: 17/900,618

(22) Filed: Aug. 31, 2022

(51) Int. Cl. A01G 3/053

(52) U.S. Cl. CPC A01G 3/0535; A01G 2003/0443

(57) ABSTRACT

Dual arm mechanical pruning apparatuses for simultaneously hedging and/or skirting trees in adjacent rows typically comprising: a mast assembly; a lift carriage assembly; two front arm assemblies, each front arm assembly comprising one or more saw blades; two lower arm assemblies, each lower arm assembly comprising one or more saw blades; two swing arms, each swing arm rotatably attached to the lift carriage, one of the two front arm assemblies and one of the two lower arm assemblies, where the two swing arms rotate, thereby extending and retracting the two front arm assemblies and the two lower arm assemblies relative to the lift carriage assembly, and where the two front arm assemblies hedge, and the two lower arm assemblies hedge or skirt trees. In some embodiments the dual arm mechanical pruning apparatus also comprises a vehicle mounting assembly.

### FIELD OF THE INVENTION

This invention relates to the field of mechanical pruning apparatuses. Specifically, embodiments of the present invention provide dual arm mechanical pruning apparatuses capable of simultaneously hedging and/or skirting trees in two adjacent tree rows.

### DISCUSSION OF THE BACKGROUND

Conventional mechanical pruners available today typically have only a single arm and/or are capable of hedging or skirting only one row of trees per pass. Although pruning may also be accomplished by hand, it has become increasingly expensive and difficult to find workers willing to hand prune. Even if workers are available to prune, the labor costs are significant, and workers may not be available for the entire duration of a pruning job.

Single arm mechanical pruners may take the place of hand labor but are replete with inefficiencies. Single arm mechanical pruners require multiple passes because they can prune only one side of one tree at a time, and in a single pass can only perform either a hedging or skirting, but not both. As a result of these inefficiencies, the single arm mechanical pruner takes additional time since workers operating the single arm mechanical pruner must make multiple passes to prune the trees, which increases the cost.

Moreover, there is a risk that pruning will not be uniform on either side of the tree rows because a single arm mechanical pruner may only prune one tree in one row at a time.

Therefore, there is a need in the art to provide an efficient mechanical pruner that (1) reduces the need for hand labor, (2) reduces the cost of labor to operate the mechanical pruner, (3) reduces the time spent pruning trees, (4) has the capability to provide both hedging and skirting in the same pass, and (5) provides more uniform pruning.

### SUMMARY OF THE INVENTION

The present invention advantageously provides dual armed mechanical pruning apparatuses that simultaneously hedge and/or skirt trees in two adjacent tree rows in one pass.

Specifically, embodiments of the invention generally comprise: (1) a mast assembly; (2) a lift carriage assembly; (3) two front arm assemblies, each front arm assembly comprising one or more saw blades; (4) two lower arm assemblies, each lower arm assembly comprising one or more saw blades; (5) two swing arms, each swing arm rotatably attached to the lift carriage, one of the two front arm assemblies and one of the two lower arm assemblies, where the two swing arms rotate, thereby extending and retracting the two front arm assemblies and the two lower arm assemblies relative to the lift carriage assembly, and where the two front arm assemblies hedge, and the two lower arm assemblies hedge or skirt trees. In some embodiments the dual arm mechanical pruning apparatus also comprises a vehicle mounting assembly.

One of the two front arm assemblies may hedge one row of trees and the other one of the front arm assemblies may simultaneously or nearly simultaneously hedge an adjacent row of trees. Similarly, one of the lower arm assemblies may either skirt or hedge one row of trees and the other one of the lower arm assemblies may either skirt or hedge an adjacent row of trees. Thus, the dual arm mechanical pruning apparatus may simultaneously or nearly simultaneously hedge, skirt and hedge, or hedge and top adjacent tree rows without the inconvenience and inefficiency of having to make two or more passes.

The arms of the dual arm mechanical pruning apparatus may be positioned (by vertical movement of the lift carriage assembly) to skirt or hedge at a height as low as a few inches above ground or may hedge or top trees at a height as high as approximately 16 feet above ground level, or anywhere in between. The angle of the two front arms assemblies may be positioned to an angle between approximately minus 45 degrees to approximately plus 75 degrees or anywhere in between. As used throughout this application, all references to a number of degrees are based on 0 degrees being vertically upwards. The lower arm assemblies may be positioned to an angle between approximately 90 degrees from vertical to approximately 225 degrees or anywhere in between. Rotating the swing arms assemblies from approximately 0 degrees to 90 degrees extends the front arm assemblies and the lower arm assemblies by approximately about 6 feet in each direction. The swing arms may be rotated anywhere from 0 degrees to 90 degrees.

In typical embodiments, the dual arm mechanical pruning apparatus may be operably connected and/or attached to a transport vehicle via a vehicle mounting assembly, which may also be operably connected and/or attached to the mast assembly.

Although typical embodiments of the dual arm mechanical pruning apparatus are hydraulically driven from hydraulic systems on the transport vehicle, the dual arm mechanical pruning apparatus may also be powered by a variety of different energy sources including, but not limited to, pneumatic or electrical sources.

### BRIEF DESCRIPTION OF THE DRAWINGS

FIG. 1A is a perspective view of a dual arm mechanical pruning apparatus with front arms and lower arms retracted, and with the front arms at 0 degrees and the lower arms at 90 degrees, according to an embodiment of the invention.

FIG. 1B is a front view of the dual arm mechanical pruning apparatus of FIG. 1A.

FIG. 1C is a right-side view of the dual arm mechanical pruning apparatus of FIG. 1A.

FIG. 1D is a top view of the dual arm mechanical pruning apparatus of FIG. 1A.

FIG. 1E is a back view of the dual arm mechanical pruning apparatus of FIG. 1A.

FIG. 1F is a bottom view of the dual arm mechanical pruning apparatus of FIG. 1A.

FIG. 1G is an exploded perspective view of the dual arm mechanical pruning apparatus of FIG. 1A.

FIG. 2A is a perspective view of a dual arm mechanical pruning apparatus with front arms and lower arms extended and with the front arms at 0 degrees and the lower arms at 90 degrees, according to an embodiment of the invention.

FIG. 2B is a front view of the dual arm mechanical pruning apparatus of FIG. 2A.

FIG. 2C is a right-side view of the dual arm mechanical pruning apparatus of FIG. 2A.

FIG. 2D is a top view of the dual arm mechanical pruning apparatus of FIG. 2A.

FIG. 3A is a perspective view of a dual arm mechanical pruning apparatus with front arms and lower arms extended, and with the front arms at 0 degrees and the lower arms at 180 degrees, according to an embodiment of the invention.

FIG. 3B is a front view of the dual arm mechanical pruning apparatus of FIG. 3A.

FIG. 3C is a right-side view of the dual arm mechanical pruning apparatus of FIG. 3A.

FIG. 4 is a perspective view of a dual arm mechanical pruning apparatus with front arms and lower arms retracted, and with the front arms at 0 degrees and the lower arms at 180 degrees, according to an embodiment of the invention.

FIG. 5A is a perspective view of a vehicle mounting assembly of a dual arm mechanical pruning apparatus according to an embodiment of the invention.

FIG. 5B is a front view of the vehicle mounting assembly of FIG. 5A.

FIG. 5C is a right-side view of the vehicle mounting assembly of FIG. 5A.

FIG. 5D is a top view of the vehicle mounting assembly of FIG. 5A.

FIG. 6A is a perspective view of a mast assembly of a dual arm mechanical pruning apparatus according to an embodiment of the invention.

FIG. 6B is a front view of the mast assembly of FIG. 6A.

FIG. 6C is a right-side view of the mast assembly of FIG. 6A.

FIG. 6D is a top view of the mast assembly of FIG. 6A.

FIG. 6E is an exploded view of the mast assembly of FIG. 6A.

FIG. 7A is a perspective view of a lift carriage assembly of a dual arm mechanical pruning apparatus according to an embodiment of the invention.

FIG. 7B is a front view of the lift carriage assembly of FIG. 7A.

FIG. 7C is a right-side view of the lift carriage assembly of FIG. 7A.

FIG. 7D is a top view of the lift carriage assembly of FIG. 7A.

FIG. 7E is a bottom view of the lift carriage assembly of FIG. 7A.

FIG. 8A is a perspective view of a right swing arm of a dual arm mechanical pruning apparatus according to an embodiment of the invention.

FIG. 8B is a front view of the right swing arm of FIG. 8A.

FIG. 8C is a left side view of the right swing arm of FIG. 8A.

FIG. 8D is a back view of the right swing arm of FIG. 8A.

FIG. 8E is an exploded view of the right swing arm of FIG. 8A.

FIG. 9A is an underneath perspective view of a left lower arm assembly of a dual arm mechanical pruning apparatus according to an embodiment of the invention.

FIG. 9B is a front view of the left lower arm assembly of FIG. 9A.

FIG. 9C is a top view of the left lower arm assembly of FIG. 9A.

FIG. 9D is a back view of the left lower arm assembly of FIG. 9A.

FIG. 9E is a bottom view of the left lower arm assembly of FIG. 9A.

FIG. 9F is an exploded view of the left lower arm assembly of FIG. 9A.

FIG. 10A is a perspective view of a right front arm assembly of a dual arm mechanical pruning apparatus according to an embodiment of the invention.

FIG. 10B is a front view of the right front arm assembly of FIG. 10A.

FIG. 10C is a top view of the right front arm assembly of FIG. 10A.

FIG. 10D is a bottom side view of the front arm assembly of FIG. 10A.

FIG. 10E is an exploded view of the front arm assembly of FIG. 10A.

### DETAILED DESCRIPTION OF THE PREFERRED EMBODIMENTS

Reference will now be made in detail to the preferred embodiments of the invention, examples of which are illustrated in the accompanying drawings. While the invention will be described in conjunction with the preferred embodiments, it should be understood that they are not intended to limit the invention to these embodiments. On the contrary, the invention is intended to cover alternatives, modifications, and equivalents that may be included within the spirit and scope of the invention as defined by the appended claims. Furthermore, in the following detailed description of the present invention, numerous specific details are set forth in order to provide a thorough understanding of the present invention. However, it will readily be apparent to one skilled in the art that the present invention may be practiced without these specific details.

Embodiments of the present invention advantageously provide dual-arm mechanical pruning apparatuses that permit hedging and/or skirting of two trees or two rows of trees simultaneously or nearly simultaneously, thus eliminating the time and labor costs to make more than one pass through a row of trees, or to hand prune rows of trees.

Typical embodiments of the invention generally comprise: (1) a mast assembly; (2) a lift carriage assembly; (3) two front arm assemblies, each front arm assembly comprising one or more saw blades; (4) two lower arm assemblies, each lower arm assembly comprising one or more saw blades; (5) two swing arms, each swing arm rotatably attached to the lift carriage assembly, one of the two front arm assemblies and one of the two lower arm assemblies, where the two swing arms rotate, thereby extending or retracting the two front arm assemblies and the two lower arm assemblies relative to the lift carriage assembly, and where the two front arm assemblies hedge, and the two lower arm assemblies hedge or skirt trees. In some embodiments the dual arm mechanical pruning apparatus also comprises a vehicle mounting assembly.

In some embodiments, the mast assembly of the dual arm mechanical pruning apparatus comprises (1) an outside mast; (2) and inside mast; and (3) at least one mast cylinder operably attached to the inside mast to move substantially vertical relative to the outside mast, thereby raising or lowering the lift carriage, lower arm assemblies and swing arms relative to the outside mast.

The following component list provides reference numbers for each component described in the exemplary embodiments below and shown on the accompanying drawings.

| Component | Reference # |
|---|---|
| Dual Arm Mechanical Pruning | 100, 200, 300, 400 |
| Apparatus | |
| Vehicle Mounting Assembly | 102, 202, 302, 402, 502 |
| Mast Assembly | 110, 210, 310, 410, 610 |
| Lift Carriage Assembly | 130, 230, 330, 430, 730 |
| Carriage Body | 131, 731 |
| Top Cover | 132, 732 |
| Proportional Valve | 133 |
| Left Swing Arm | 140A, 240A, 340A, 440A |
| Right Swing Arm | 140B, 240B, 340B, 440B, 840B |
| Left Lower Arm Assembly | 150A, 250A, 350A, 450A, 950A |
| Right Lower Arm Assembly | 150B, 250B, 350B, 450B |
| Left Front Arm Assembly | 170A, 270A, 370A, 470A |
| Right Front Arm Assembly | 170B, 270B, 370B, 470B, 1070B |
| Front Actuator | 181, 281, 381, 481 |
| Rear Actuator | 182, 282, 381, 482 |
| Shock | 183, 283, 383, 483 |
| Left Pivot | 184A, 284A, 384A |
| Right Pivot | 184B, 284B, 384B, 484B |
| Swing Arm Cylinder | 185, 285, 385 |
| Swing Cylinder Lower Pin | 186, 286, 386 |
| Swing Cylinder Upper Pin | 187, 287, 387 |
| Swing Arm Pin | 188, 288, 388 |
| Main Mounting Member | 503 |
| Vehicle Mounting Plate LH | 504A |
| Vehicle Mounting Plate RH | 504B |
| Mast Mounting Plate LH | 505A |
| Mast Mounting Plate RH | 505B |
| Coupling Manifold | 506 |
| Center Plate | 507 |
| Cutouts | 508, 509 |
| Outside Mast | 611 |
| Inside Mast | 612 |
| Linear bearing | 613 |
| First Hose Roller | 614 |
| Second Hose Roller | 615 |
| Chain Roller | 616 |
| Mast Cylinder | 617 |
| Chain | 618 |
| Vertical Mounting Plate | 619 |
| Hose | 620 |
| Hose | 621 |
| Hose | 622 |
| Mast Proportional Valve | 623 |
| Tensioner | 624 |
| Lower Pin | 625 |
| Upper Pin | 626 |
| Counterbalance Valve | 627 |
| Counterbalance Valve | 628 |
| Inside Mast Mounting Plates | 734A, 734B |
| Valve mounting plate | 735 |
| Cutouts | 736 |
| Bearing Holes | 737 |
| Chain Holes | 738 |
| Bushings | 739 |
| Swing Arm Plates | 841A, 841B |
| Swing Plate Connector | 842 |
| Swing Tube | 843 |
| Swing Arm Ears | 144, 844 |
| Actuator Mounting Plates | 845A, 845B |
| Center Plates | 846A, 846B |
| Holes | 847A, 847B |
| Slot | 848 |
| Left Lower Arm | 951A |
| Motor | 952 |
| Saw Drive/Pulley | 953 |
| Belt | 954A, 954B, 954C |
| Blade Drive | 955 |
| Saw Blade | 956 |
| Shock Mount | 957 |
| Tree Guard | 958 |
| Saw Beam Skid | 959 |
| Lower Arm Bracket | 960A, 960B |
| Bushings | 961 |
| Right Front Arm | 1071B |
| Motor | 1072 |
| Saw Drive/Pulley | 1073 |
| Belts | 1074A, 1074B, 1074C |
| Blade Drive | 1075 |
| Saw Blade | 1076 |
| Motor Guard | 1079 |
| Front Rotary Mounting Portion | 1080B |

Exemplary Operational Embodiments

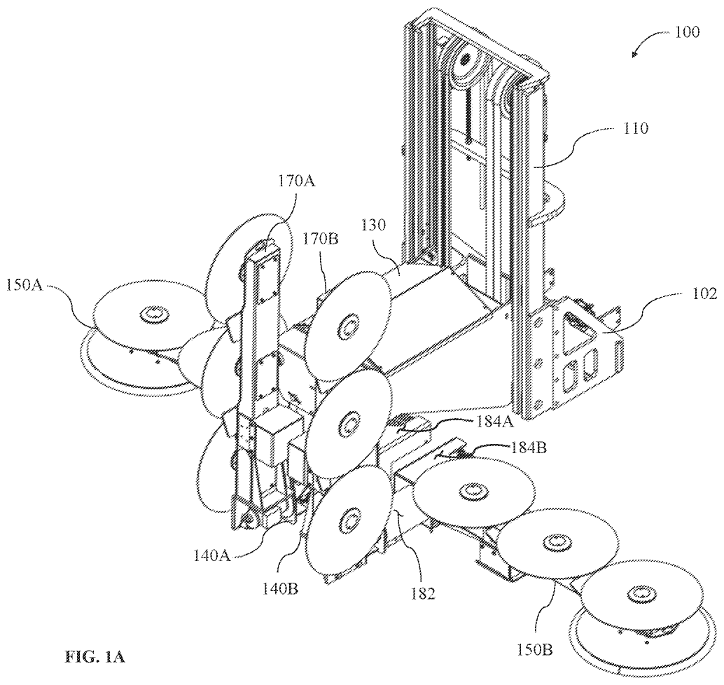

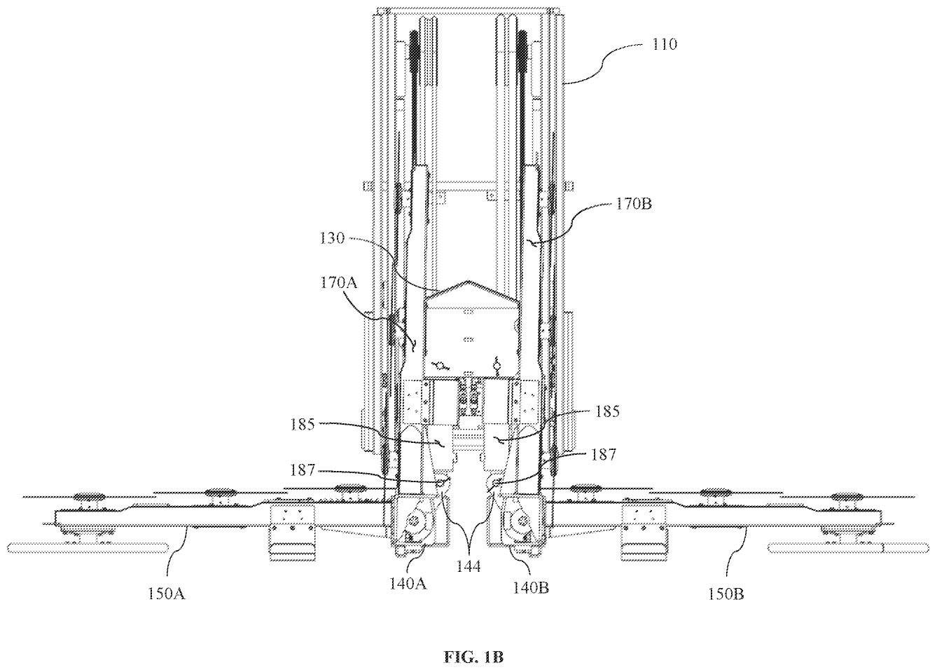

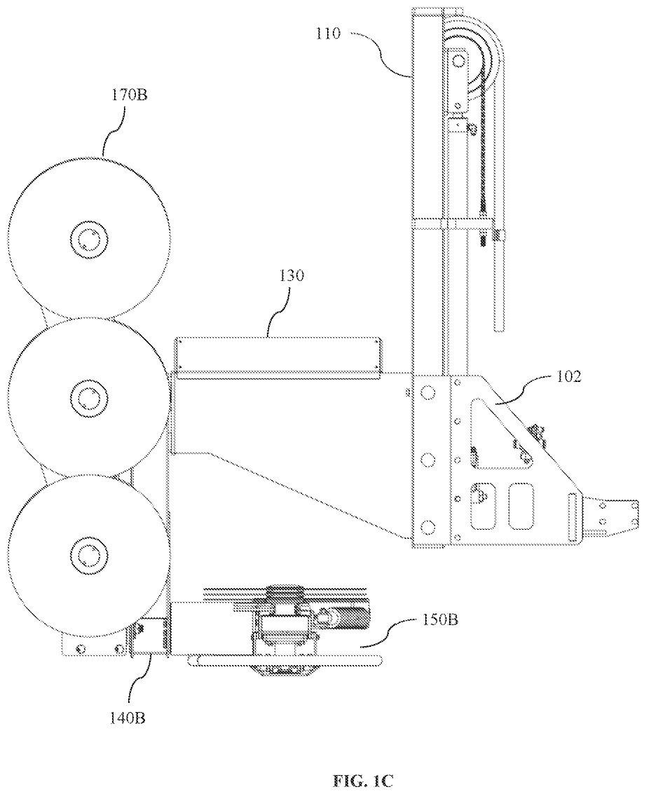

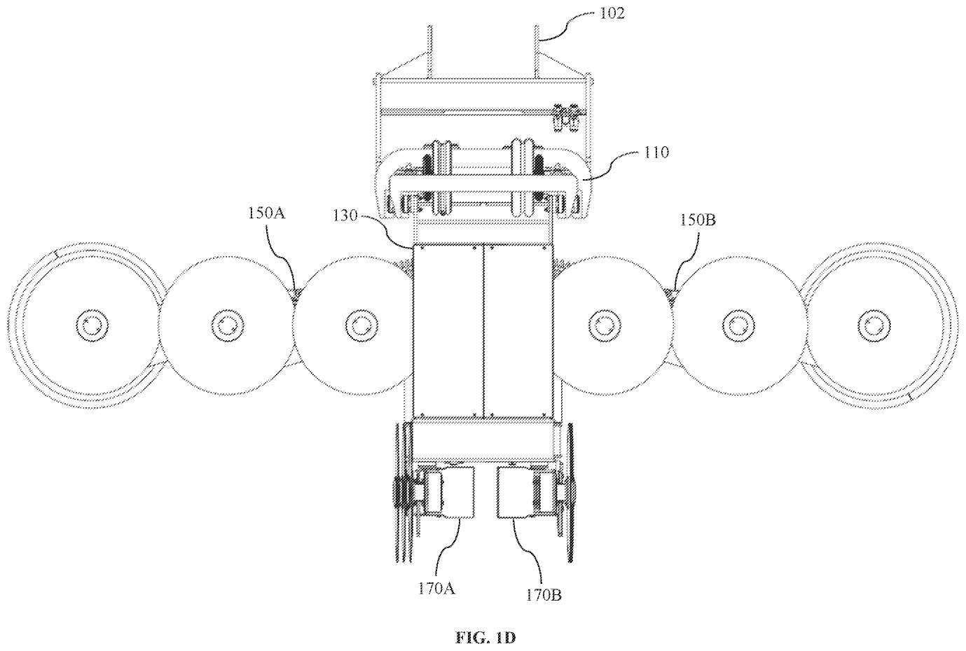

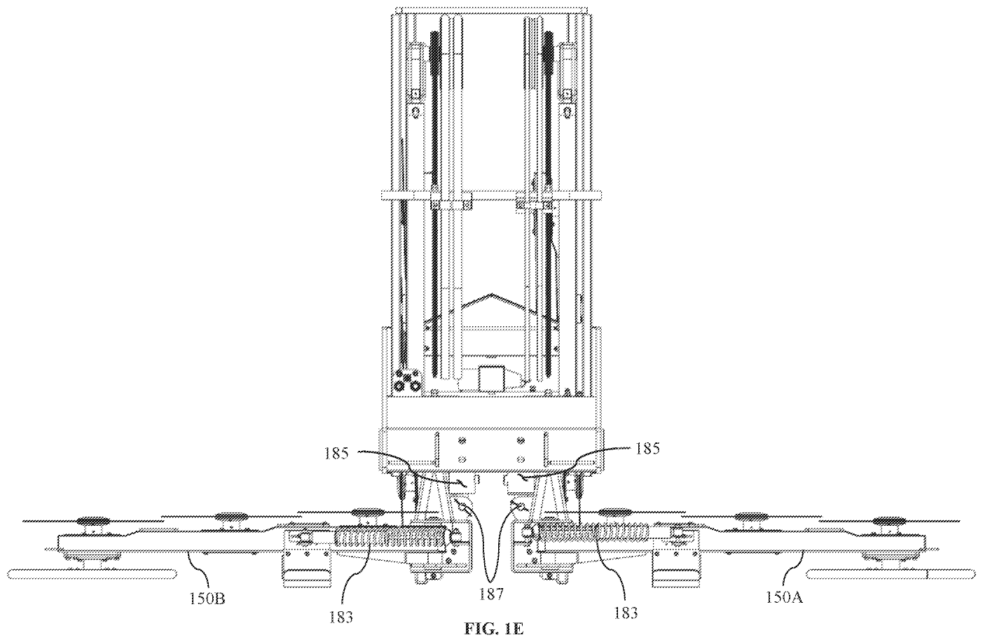

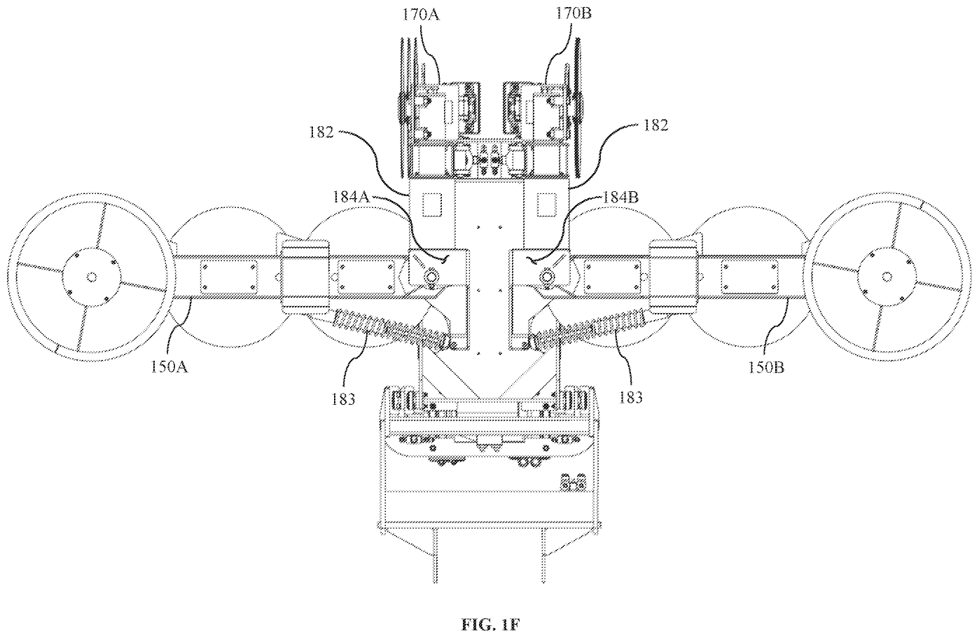

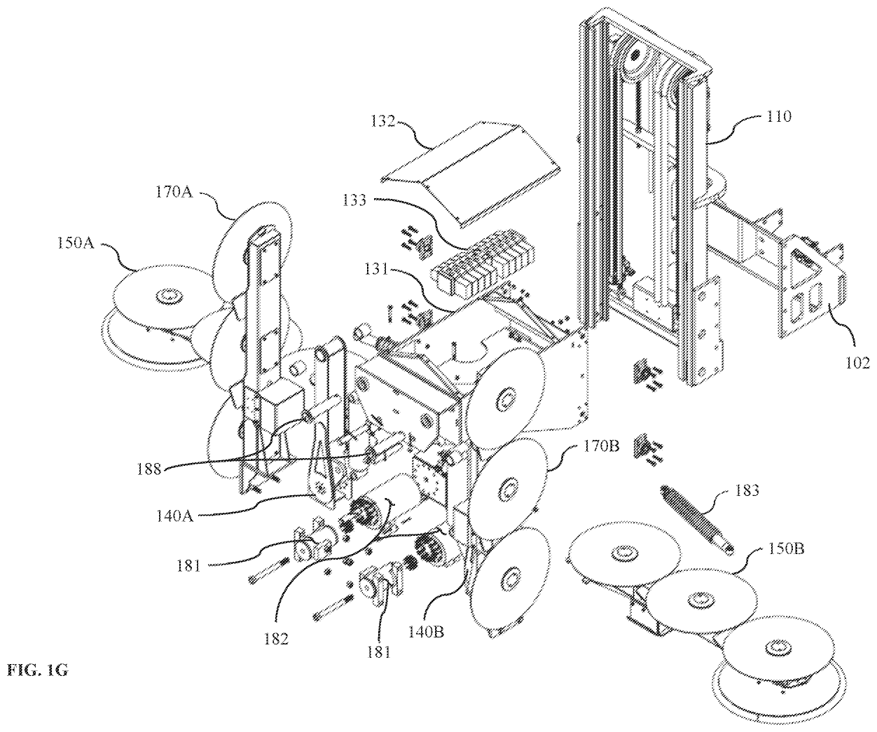

Various positions of the front arm assemblies, lower arm assemblies and swing arms, as well as related components may be seen in FIGS. 1A-1G, 2A-2D, 3A-3C and 4.

Simultaneous Hedging/Skirting Narrowly Spaced Tree Rows

Referring first to FIGS. 1A-1G, therein is shown an exemplary dual arm mechanical pruning apparatus 100 comprising a tractor mounting assembly 102, a mast assembly 110, a lift carriage assembly 130, two swing arms 140A, 140B, two lower arm assemblies 150A, 150B, and two front arm assemblies 170A, 170B. The two swing arms 140A, 140B in FIGS. 1A-1G are shown at 0 degrees (substantially vertical) and, as a result, the lower arms assemblies 150A, 150B and front arm assemblies 170A, 170B are retracted (at their closest position to the lift carriage assembly 130).

The lower arm assemblies 150A, 150B of FIGS. 1A-1G are shown at 90 degrees (substantially horizontal). When at 90 degrees, the lower arm assemblies 150A, 150B are utilized for skirting rows of trees (e.g., citrus trees). The front arm assemblies 170A, 170B of FIGS. 1A-1G are shown at 0 degrees (substantially vertical). When at 0 degrees, the front arm assemblies 170A, 170B may be used for hedging rows of trees. Although shown at 0 degrees, the front arm assemblies may operate at anywhere from minus 45 degrees to plus 75 degrees so as to hedge rows of trees such that the tops of the trees are wider than the bottoms of the trees after hedging, or conversely, the tops of the trees are narrower than the bottoms of the trees after hedging.

Simultaneous Hedging/Skirting Widely Spaced Tree Rows

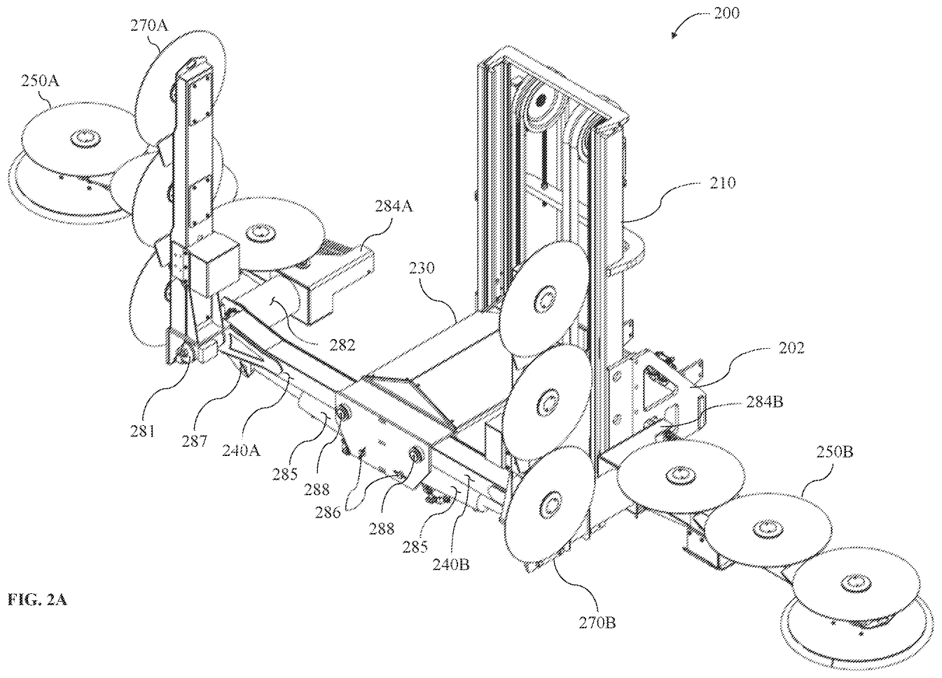

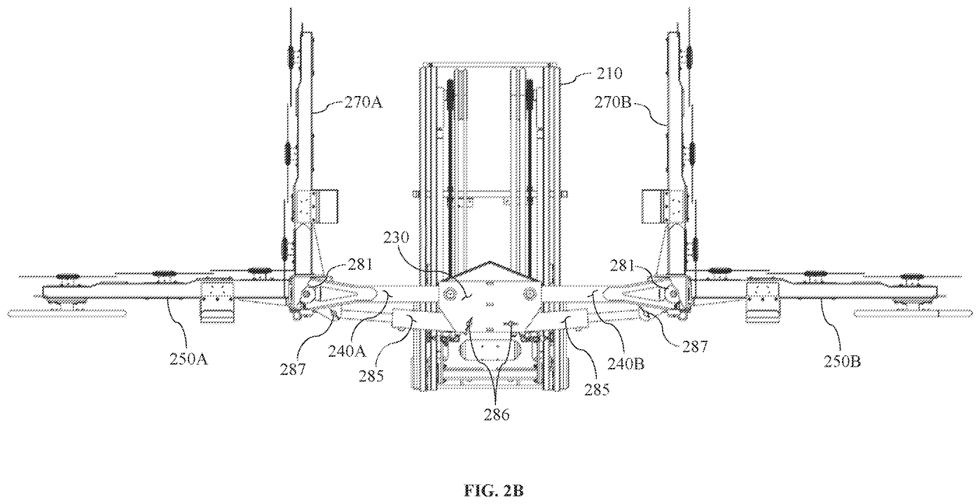

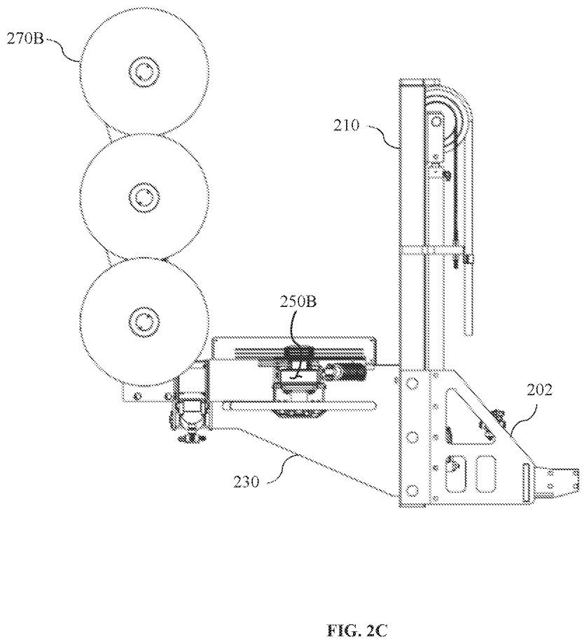

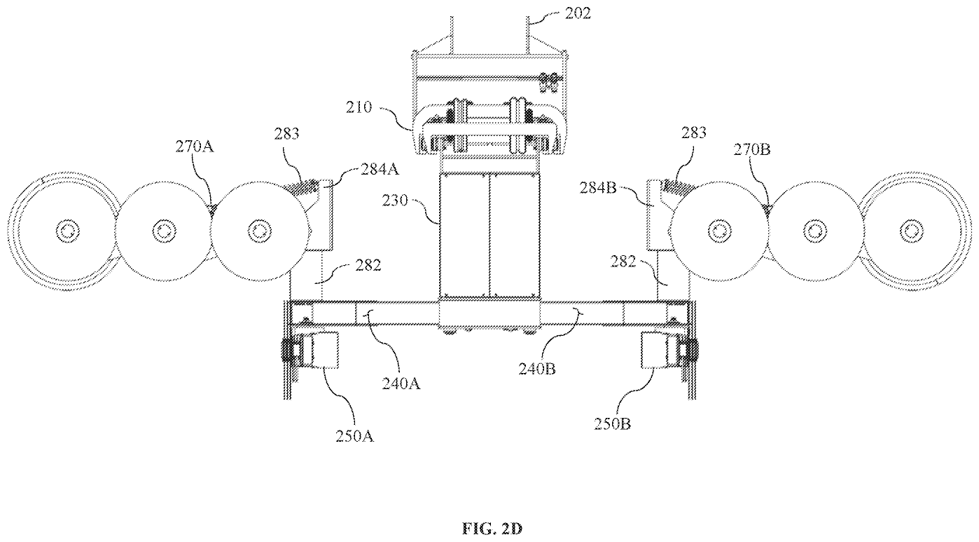

Referring to FIGS. 2A-2D, therein is shown an exemplary dual arm mechanical pruning apparatus 200 comprising a vehicle mounting assembly 202, a mast assembly 210, a lift carriage assembly 230, two swing arms 240A, 240B, two lower arm assemblies 250A, 250B, two front arm assemblies 270A, 270B. The two swing arms 240A, 240B in FIGS. 2A-2D are shown at 90 degrees (substantially horizontal) and, as a result, the lower arms assemblies 250A, 250B and front arm assemblies 270A, 270B are extended (at their farthest position from the lift carriage assembly 230).

The two swing arms 240A, 240B may operate at any position between approximately 0 degrees (substantially vertical) and approximately 90 degrees (substantially horizontal; e.g., 0, 2, 8, 15, 22.5, 30, 38, 45, 59, 66, 75, 82, 90, etc. degrees) such that the lower arm assemblies 250A, 250B and the front arm assemblies 270A. 270B may be in any position between fully retracted and fully extended. When fully retracted, the swing arms assemblies 240A, 240B may be as close as approximately 2.5 feet apart from centerline to centerline of the swing arms, and the front arm assemblies 270A, 270B may be as close as approximately 4 feet apart from outside face of saw blade to outside face of saw blade. When the swing arms 240A, 240B are fully extended, the front arm assemblies 270A, 270B may be as far apart as 20 feet from outside face of saw blade to outside face of saw blade.

Hedging Widely Spaced Tree Rows

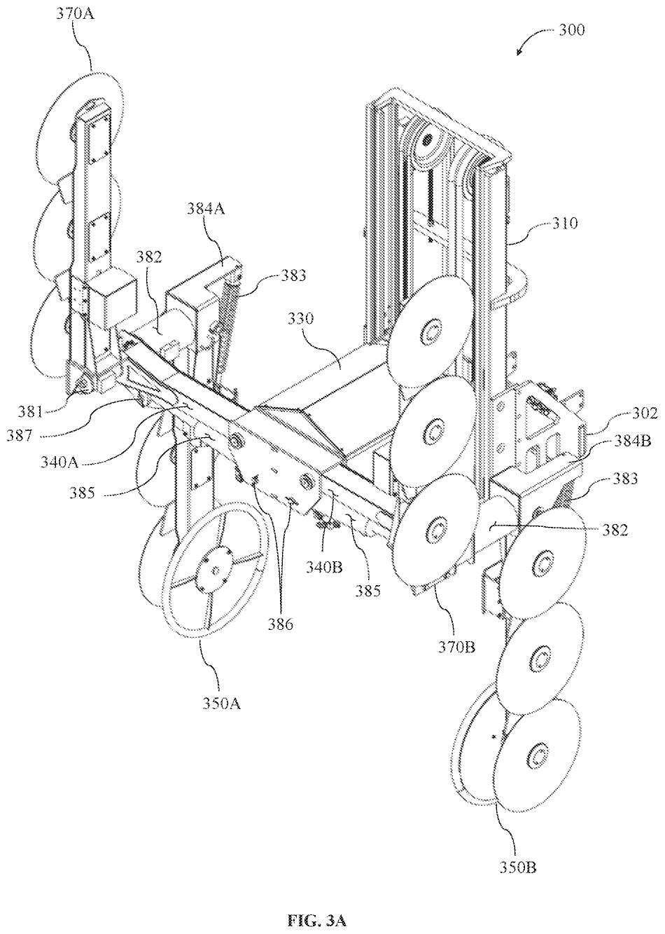

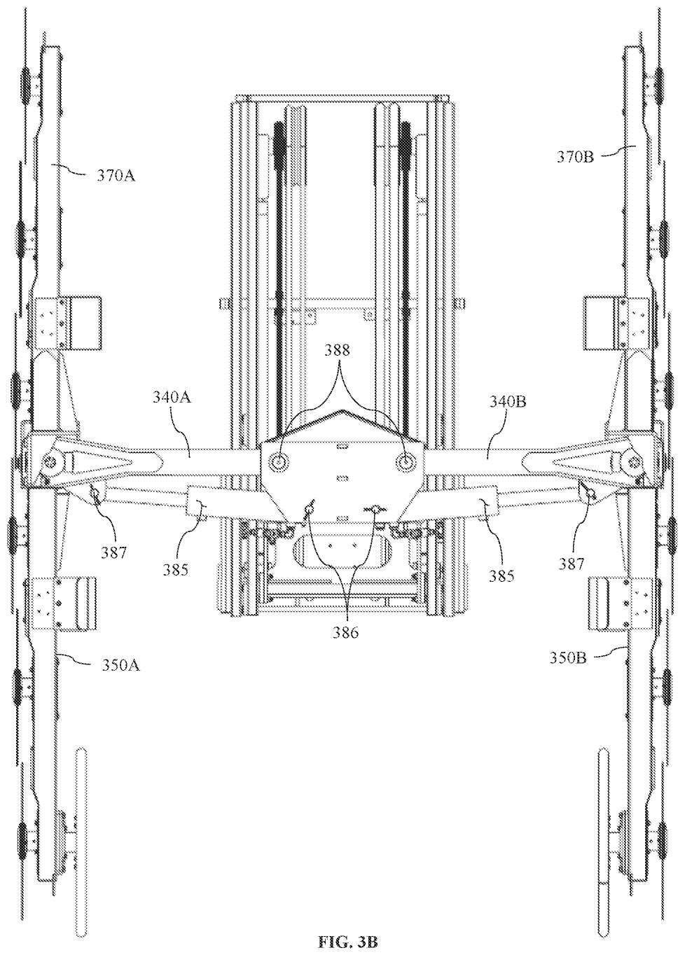

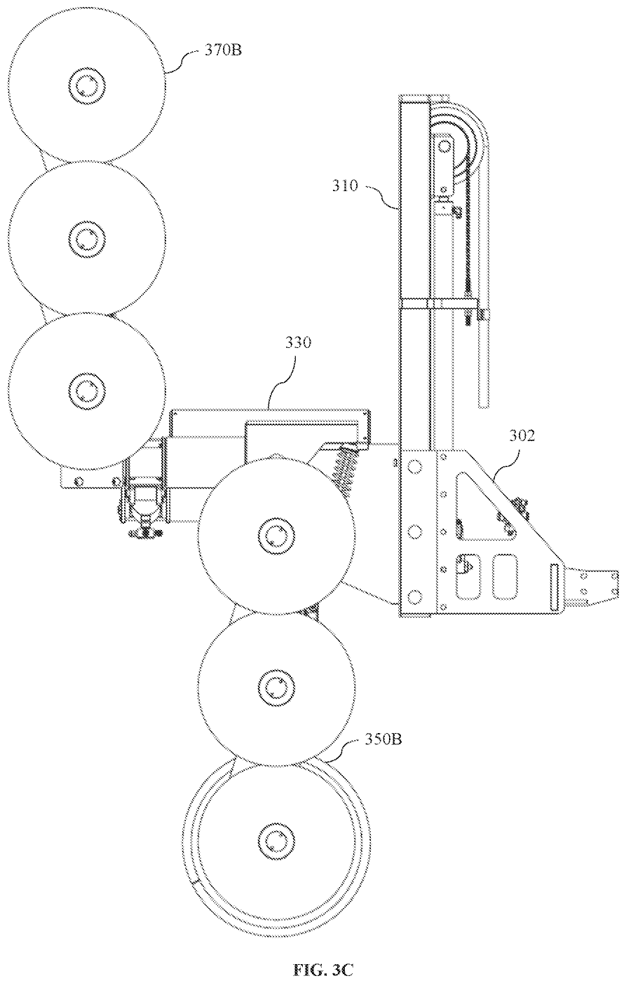

In FIGS. 3A-3C is shown an exemplary dual arm mechanical pruning apparatus 300 comprising a vehicle mounting assembly 302, a mast assembly 310, a lift carriage assembly 330, two swing arms 340A, 340B, two lower arm assemblies 350A, 350B, and two front arm assemblies 370A, 370B. Similar to the swing arms 240A, 240B of FIGS. 2A-2D, the two swing arms 340A, 340B of FIGS. 3A-3C are shown at 90 degrees (substantially horizontal) position and, as a result, the lower arms assemblies 350A, 350B and front arm assemblies 370A, 370B are fully extended (at their farthest position from the lift carriage assembly 330).

The lower arms assemblies 350A, 350B of FIGS. 3A-3C are shown at approximately 180 degrees (substantially vertical downward). In this position, the lower arm assemblies 350A, 350B work in conjunction with the front arm assemblies 370A, 370B to hedge rows of trees. The lower arm assemblies 370A, 370B may operate anywhere from approximately 90 degrees (skirting position) to approximately 225 degrees. For example, the arms may operate at 90, 95, 98, 103, 115, 128, 141, 150, 166, 172, 194, 200, 205, 218, etc. degrees.

Hedging Narrowly Spaced Tree Rows

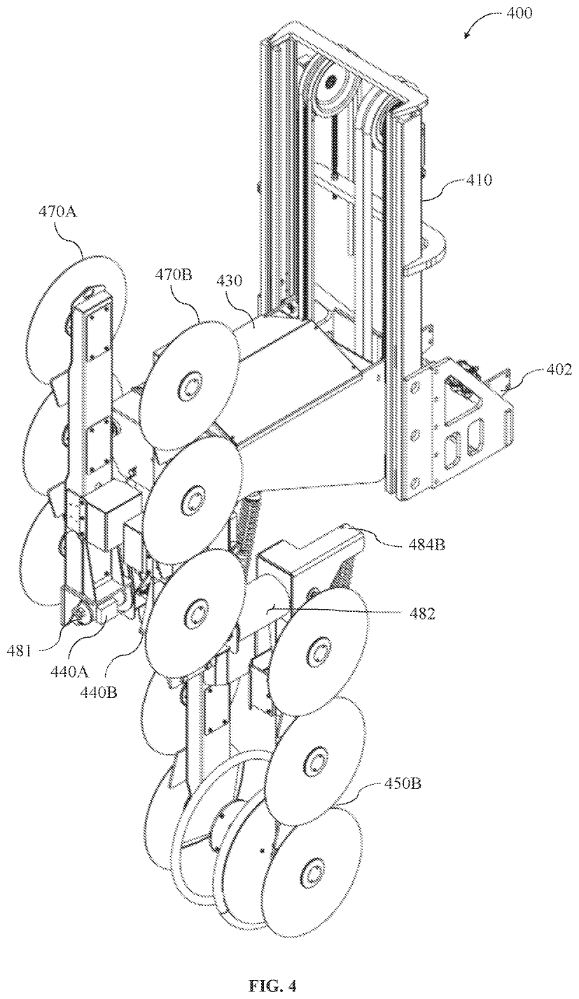

Referring now to FIG. 4, therein is shown an exemplary dual arm mechanical pruning apparatus 400 comprising a vehicle mounting assembly 402, a mast assembly 410, a lift carriage assembly 430, two swing arms 440A, 440B, two lower arm assemblies 450A, 450B, and two front arm assemblies 470A, 470B. Like the swing arms 140A, 140B of FIGS. 1A-1G, the two swing arms 440A, 440B are shown at 0 degrees (substantially vertical), and as a result, the lower arms assemblies 450A, 450B and front arm assemblies 470A, 470B are retracted (at their closest position to the lift carriage assembly 430).

Like the lower arm assemblies 350A, 350B of FIGS. 3A-3C, the lower arm assemblies 450A, 450B of FIG. 4 are shown at 180 degrees (substantially vertical downward) and, as described above, may be used in conjunction with front arm assemblies 470A, 470B, for hedging. As described in reference to lower arm assemblies 350A, 350B of FIGS. 3A-3F, the lower arms assemblies 450A, 450B may operate in any position between approximately 90 degrees and approximately 225 degrees.

Vehicle Mounting Assembly

Generally, a vehicle mounting assembly connects and/or attaches a mast assembly of a dual arm mechanical pruning apparatus to a transport vehicle (e.g., a tractor).

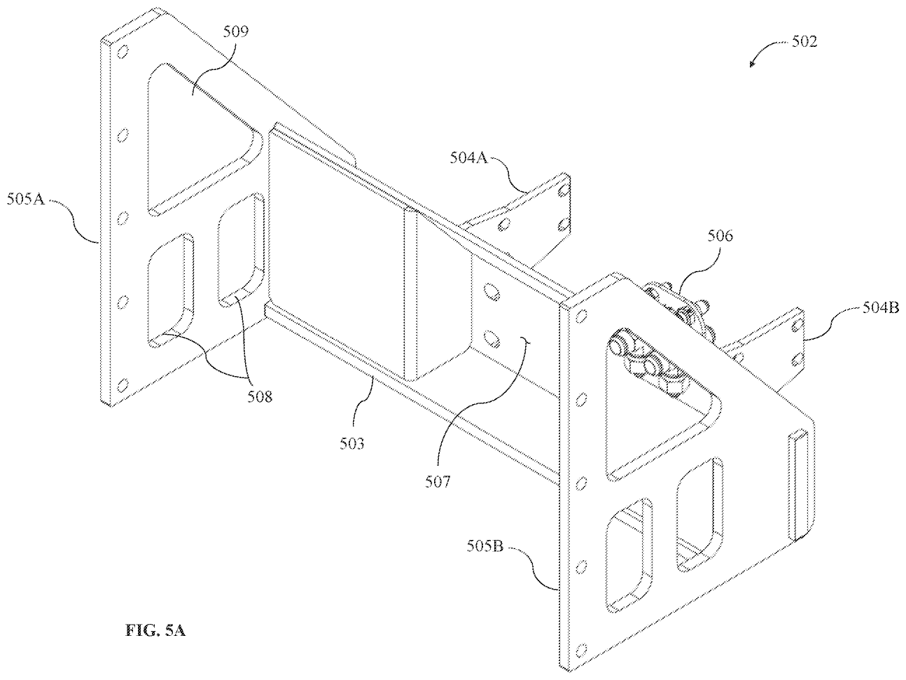

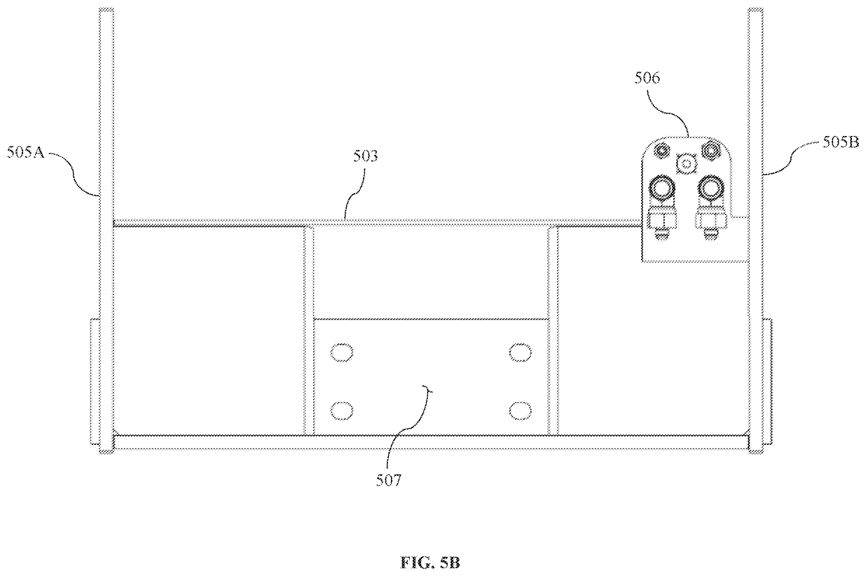

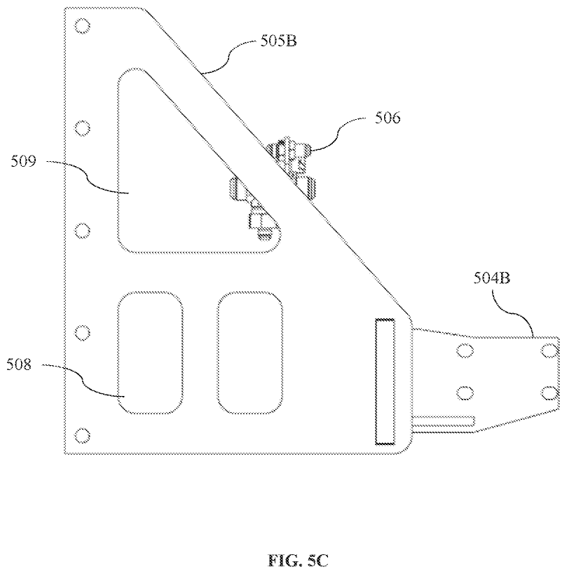

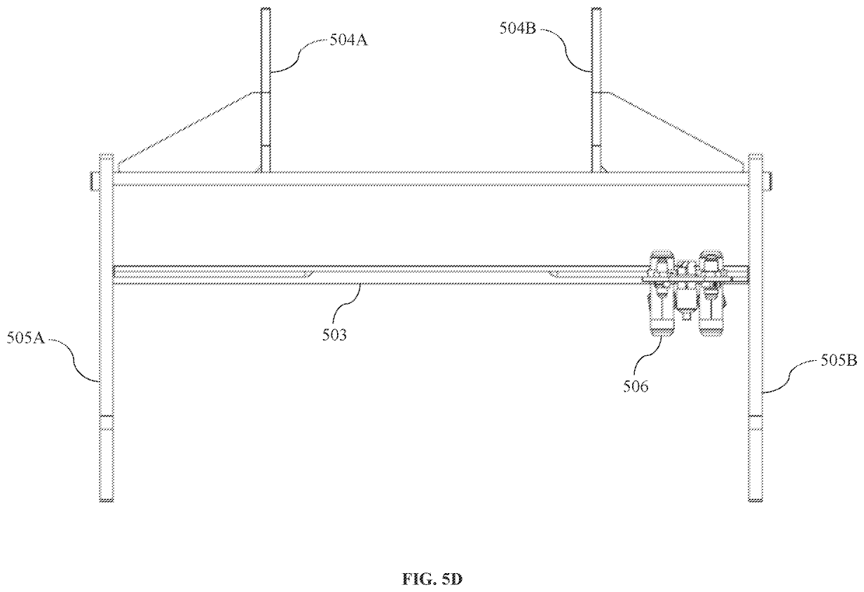

Referring now to FIGS. 5A-5D, therein is shown an exemplary vehicle mounting assembly 502 comprising: (i) a main mounting member 503; (ii) vehicle mounting plates 504A, 504B; (iii) outside mast mounting plates 505A, 505B; and (iv) a coupling manifold. The main mounting member 503 as shown in FIGS. 5A-5D comprises a plurality of plates, one of the plurality of plates being a center plate 507, which may be utilized for connection and/or attachment to a transport vehicle.

Typically, as shown in FIGS. 5A and 5B, the center plate 507 contains a number of holes (e.g., four) for connection/attachment of the center plate 507 to a vehicle (e.g., a tractor) using bolts, nuts, washers and/or other standard fasteners. However, the center plate 507 may contain any number of holes for use in connecting and or attaching the vehicle mounting assembly 502 to a vehicle. More generally, the main mounting member may comprise various plates, bars, angles, channels etc., one or more of which may comprise a plurality of through holes or threaded holes for connecting and/or attaching the main mounting member 503 to a vehicle by means of screws, bolts, nuts, washers, lock washers, or other conventional means of attachment.

Vehicle mounting plates 504A, 504B of FIGS. 5A-5D are generally attached and/or connected (e.g., by welding, tack welding, brazing, soldering, etc.) to the main mounting member 503, each adjacent and perpendicular to opposite ends of the center plate 507. Each of the vehicle mounting plates 504A, 504B comprise a plurality (typically four) of through holes or alternatively, threaded holes. Vehicle mounting plates 504A, 504B, in conjunction with center plate 507 fixedly attach the vehicle mounting assembly 502 to a vehicle.

As best shown in FIG. 5A, the mast mounting members 505A, 505B comprise a plurality of through holes (or alternatively threaded holes) for attaching and/or connecting the vehicle mounting assembly to the mast assembly (e.g., mast assembly 110 of FIGS. 1A-1G) of the dual armed mechanical pruning apparatus utilizing bolts, nuts, washers, lock nuts, lock washers, etc. Each of the outside mast mounting plates 505A, 505B are attached and/or connected at opposite ends of the main mounting member 503 (e.g., by welding, tack welding, brazing soldering, etc.). Additionally, in some embodiments the outside mast mounting plates 505A, 505B may have cutouts 507, 508. Cutouts may decrease the weight of the vehicle mounting assembly 502 without significantly affecting the strength of the assembly. Additionally, the cutouts in mast mounting plate 505A may provide easy access to the coupling manifold 506 when the vehicle mounting assembly 502 is attached and/or connected to a mast assembly.

Generally, the vehicle mounting assembly may comprise a variety of plates, angles, channels, tubing, etc., and its various components may comprise, carbon steel, alloy steel, stainless steel, aluminum, and or other types of metals.

The coupling manifold 506 may be used to connect a plurality of hoses (e.g., hydraulic and/or pneumatic hoses) from a pump or other components located on a vehicle (e.g., a tractor) to cylinders, valves, motors and/or other components on the dual arm mechanical pruning apparatus. The coupling manifold 506 may comprise conventional couplings and/or fittings as necessary to make the appropriate connections or may comprise a premanufactured device for coupling of a variety of sizes and types of hoses.

Mast Assembly

Generally, the mast assembly (at its back) is attached to a vehicle mounting assembly and (at its front) to a lift carriage assembly. In operation, the mast assembly moves the lift carriage assembly and components attached to the lift carriage assembly (e.g., the swing arms) vertically up and down to adjust the height at which hedging and/or skirting of tree rows is performed.

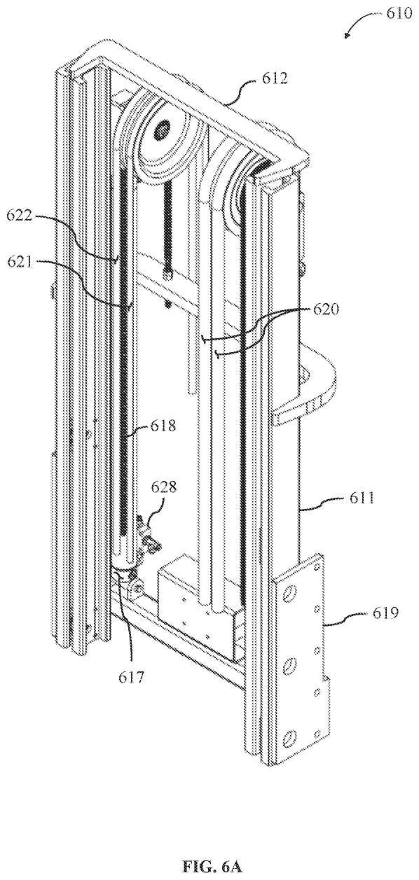

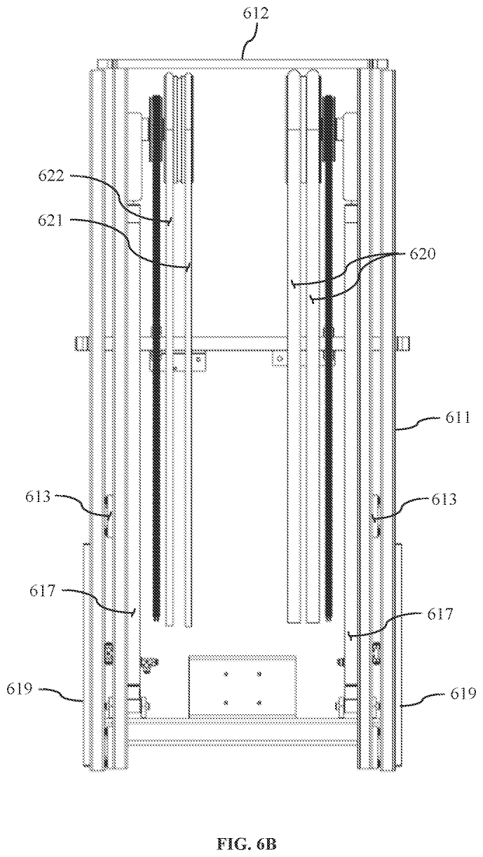

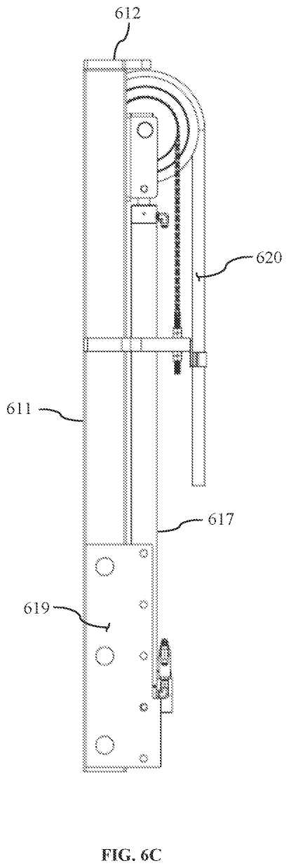

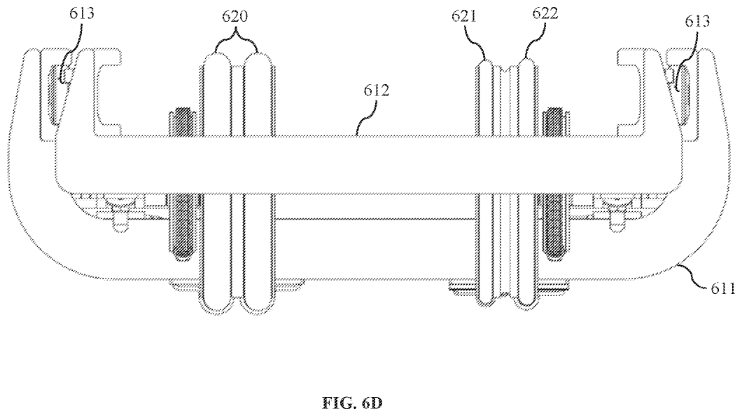

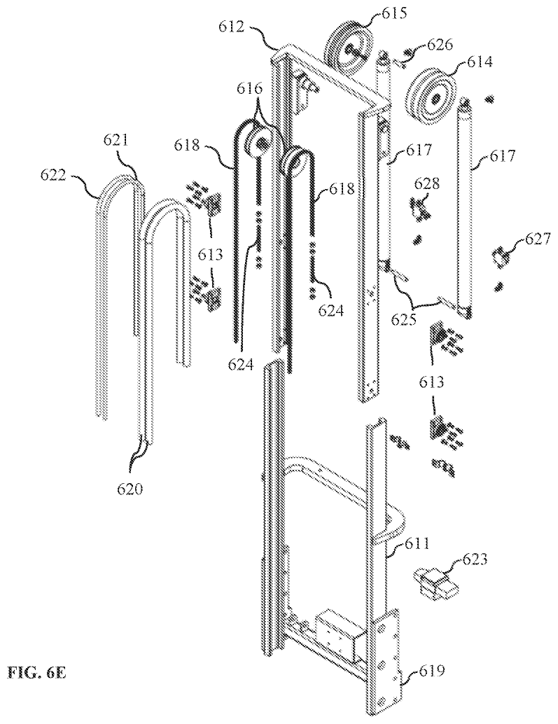

In FIGS. 6A-6E is shown a mast assembly 610 comprising an outside mast 611, and inside mast 612, a plurality of linear bearings 613, a first hose roller 614, a second hose roller 615, two chain rollers 616, two cylinders 617, chains 618, and hoses 620-622. In some embodiments, the mast assembly 610 may also comprise proportional valve 623 and/or counterbalance valves 627, 628.

In the embodiment shown in FIGS. 6A-6E, the outside mast 611 comprises vertical mounting plates 619, which may be used to attach and/or connect the mast assembly 610 to a vehicle mounting assembly (see e.g., vehicle mounting assembly 502 of FIG. 5A-5D) by way of outside mast mounting plates (see e.g., outside mast mounting plates 505A, 505B of FIG. 5A-5D). The vertical mounting plates 619 may be attached and/or connected to the outside mast mounting plates using bolts, nuts, washers, screws, or other conventional fasteners, or vertical mounting plates 619 may be welded, tack welded, soldered, etc. to outside mast mounting plates to attach and/or connect the outside mast 611 to the vehicle mounting assembly.

The plurality of linear bearings 613 permit the inside mast 612 to travel freely, and without binding vertically up and down within the outside mast 611 such that the inside mast 612 may be substantially contained within the outside mast 611 (when the inside mast is in its fully lowered position) or may extend upwardly such that the majority of the inside mast 612 is above the outside mast 611 (when the inside mast is in its fully raised position).

Cylinders 617 may be hydraulic or pneumatically actuated and are each operably attached and/or connected to the outside mast 611 (e.g., at the base of the cylinder) and operably attached to the inside mast 612 (e.g., at the piston end of the cylinder), such that when actuated, the cylinders move the inside mast 612 from a fully lowered position to a fully raised position (or anywhere in between). The top of the inside mast 612, when in its fully raised position, may be approximately 16 feet from the ground (approximately 12 feet from a bottom of the outside mast 611) and when in its fully lowered position may be 8 feet from the ground (approximately 4 feet from the bottom of the outside mast 611). Most typically, the top of the inside mast 612 is 14 feet in its fully raised position and 10 feet in its fully lowered position relative to the ground. Each of the cylinders 617 may be operably connected at its base to outside mast 611 by a lower pin 625 and may be operably connected at its piston end to the inside mast 612 by upper pin 626 and/or other conventional fasteners. Although the embodiment of the mast assembly 610 shown in FIGS. 6A-6E comprises two cylinders 617, in other embodiments, the number of cylinders may any number from a single cylinder to four cylinders.

First and second hose rollers 614, 615 permit the effective length of hoses 620-622 to lengthen and shorten as needed as the inside mast 612 moves up and down within the outside mast 611. In other words, when the inside mast 612 is in its fully lowered position, the extra length of hoses 620-622 is taken up because hoses 620-622 are effectively doubled over hose rollers 614, 615, thereby decreasing their effective length by approximately one half. In contrast, when the inside mast 612 is in its fully extended position, the effective length of hoses 614, 615 is effectively increased because very little, if any, of hoses 620-622 are doubled over rollers 614, 615, and most, if not all, of the length of hoses 620-620 are extended. Although the embodiment of the mast assembly 610 shown in FIGS. 6A-6E comprises four hose rollers (accommodating two hoses each), the number of hose rollers as well as the number of hoses accommodated by each hose roller may vary. Hoses and hose rollers may be of conventional construction and materials.

Similarly, chain rollers 616 allow chains 618 to “lengthen” and “shorten” as needed as the inside mast 612 moves up and down within the outside mast. The chains 618 are attached and/or connected to the outside mast 611 and assist and/or aid in stabilizing the inside mast 612 as it moves up and down within the outside mast 611. In some embodiments, each of chains 618 may comprise a chain tensioner 624 to adjust the tension on the chain at the initial commissioning of the dual arm mechanical pruning apparatus, or as the chains 618 wear and/or elongate. Like the hoses 620-622 and hose rollers 614, 615 described above, the number of chain rollers and the number of chains may vary. Chain rollers, chains and tensioners may be of conventional construction and materials.

Some embodiments have one or more mast proportional valves 623 to control the direction, pressure and flow of fluid within the cylinders 617. Alternatively, or in addition, some embodiments may comprise counterbalance valves 627, 628 to manage pressures and help prevent uncontrolled or uninitiated movement of the inside carriage 612 as well as to prevent damage to the dual arm mechanical pruning apparatus 610.

Generally, the mast assembly may comprise a variety of plates, angles, channels, tubing, etc., and its various components may comprise, carbon steel, alloy steel, stainless steel, aluminum, tool steel, and or other types of metals. In some embodiments, some components may be comprised of one or more types of plastic, including but not limited to Polyethylene Terephthalate (PET or PETE), High-Density Polyethylene (HDPE), Polyvinyl Chloride (PVC), Low-Density Polyethylene (LDPE), or Polypropylene (PP), and/or Polystyrene (PS).

Lift Carriage Assembly

Generally, the lift carriage at its rear is attached to inside mast of the mast assembly and moves up and down as the inside mast moves up and down relative to the outside mast. The swing arms and swing arm cylinders (which operate to rotate the swing arms) are attached to the front of the lift carriage assembly, and as the lift carriage assembly moves up and down, the swing arms and the components connected to swing arms (e.g., the lower arm assemblies and the front arm assemblies) move up and down as well, thereby adjusting the height at which hedging and/or skirting is performed.

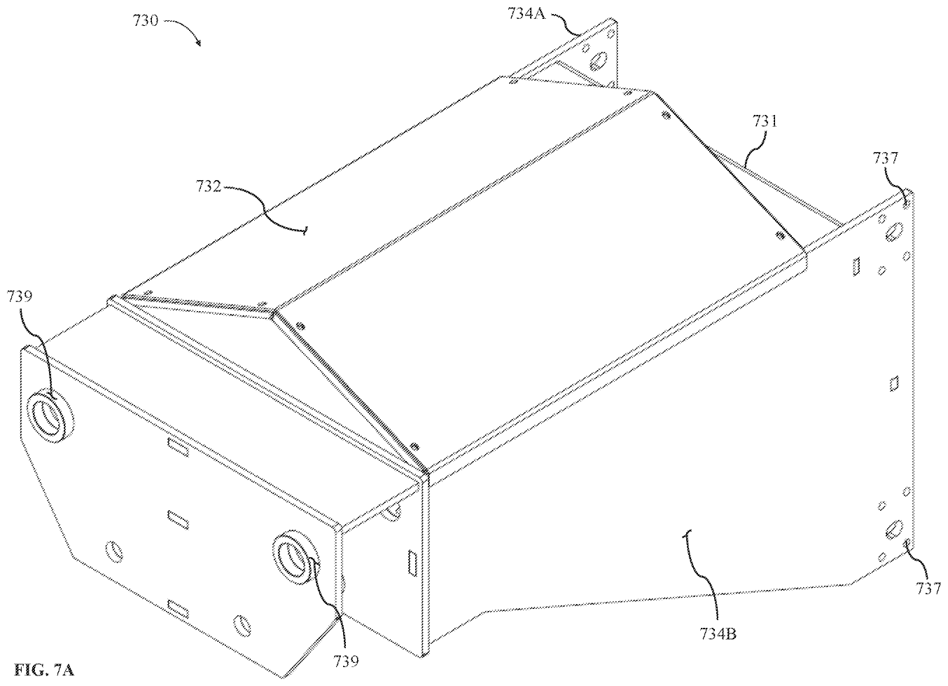

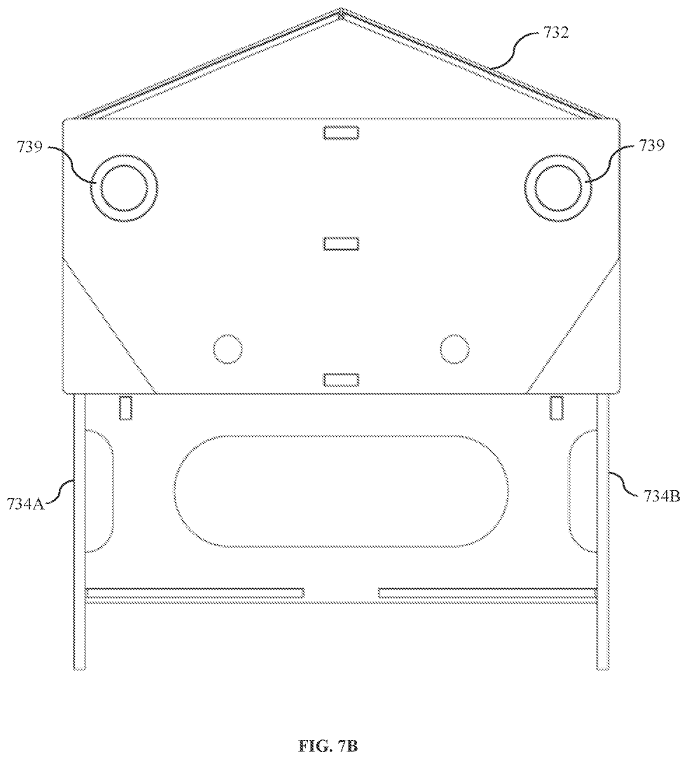

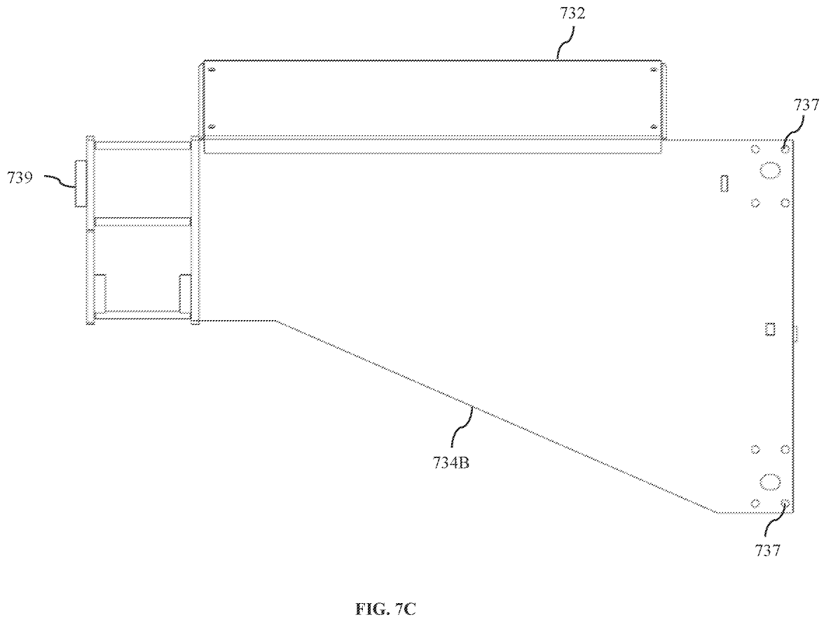

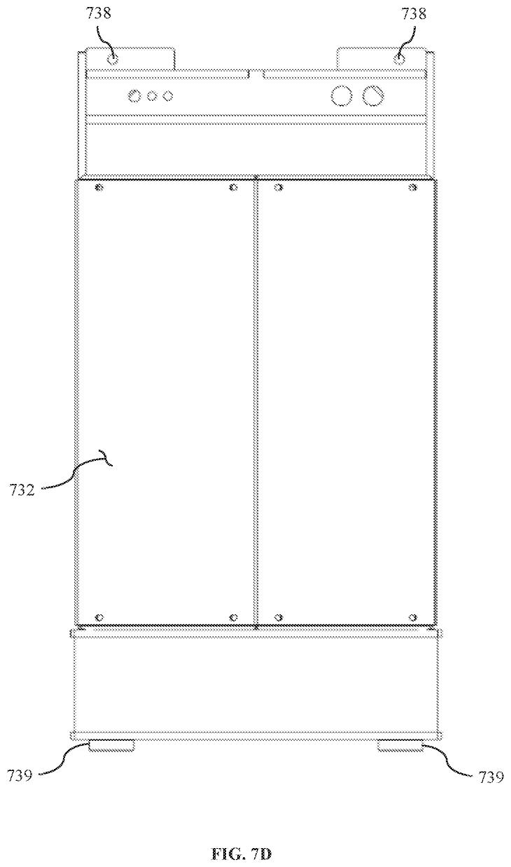

Referring now to FIGS. 7A-7E, therein is shown a lift carriage assembly 730 according to an embodiment of the present invention. The lift carriage assembly 730 typically comprises: a carriage body 731 and a top cover 732 (see also carriage body 131 and top cover 132 of FIG. 1G), and one or more proportional valves (not shown; see e.g., proportional valves 133 of FIG. 1G) located within the lift carriage assembly 730. The top cover 732 may be attached to the carriage body 731 by any conventional means in the art, including but not limited to, bolting, screwing, clamping, pinning, etc.

As best seen in FIG. 7E, the carriage body 731 may also comprise a valve mounting plate 735 for securing and/or connecting the proportional valve to the carriage body by conventional means (e.g., using screws, bolts, nuts, washers, lock washers, etc.). Typically, the valve mounting plate 735 may comprise cutouts 736 to reduce the overall weight of the lift carriage 730 and, in some embodiments, to allow hoses (e.g., hydraulic or pneumatic) and/or electrical wire/conduit to be fed through the bottom plate 735 to the inside of the carriage body 731. The valve mounting plate 735 may also comprise a plurality of holes for mounting the one or more proportional valves.

Additionally, the carriage body 731 may comprise inside mast mounting plates 734A, 734B for attaching and/or connecting the lift carriage assembly 730 to the inside mast and linear bearings (see e.g., inside mast 611 and linear bearings 613 of FIGS. 6A-6E). The inside mast mounting plates 734A, 734B (as best seen in FIGS. 7A and 7C) generally comprise a plurality of bearing holes 737 for connecting or attaching the inside mast mounting plates 734A, 734B to the mast and linear bearings (e.g., using bolts, nuts, washers, screws, pins etc.).

The carriage body 731 may be constructed of various plates, angles and/or channels and may comprise chain holes 738 (typically two) for connecting and/or attaching one or more chains (e.g., chains 618 of FIGS. 6A-6D) to the carriage body 731. The chains may be connected and/or attached to the carriage body 731 using conventional connectors and fittings. The chains may assist in and/or stabilize the lift carriage 730 as it moves vertically upwards and downwards with the inside mast (e.g., inside mast 611 of FIGS. 6A-6D).

Generally, the lift carriage assembly may comprise a variety of plates, angles, channels, etc., and its various components may comprise, carbon steel, alloy steel, stainless steel, aluminum, tool steel, and or other types of metals and/or plastics.

The carriage body 731 may also comprise bushings 739 to which swing arms (see e.g., swing arms 140A, 140B of FIGS. 1A-1G) are operably attached (e.g., using pins, shafts, round bar stock, etc.).

Swing Arms

Generally, the swing arms are operably attached at one end to the front of the lift carriage and, thus, move up and down as the lift carriage moves up and down. The other ends of the swing arms are operably connected to several other components of the dual arm mechanical pruning apparatus. Specifically, each of the other ends of the swing arms are operably connected to a swing cylinder (typically, the piston end of the swing cylinder), which rotates the swing arm from a vertical position to a horizontal position, and two actuators, one of which is connected to and rotates the front arms and the other of which is connected to and rotates the lower arms. In operation, the rotation of the swing arms from a vertical position to a horizontal position and back extends and retracts the lower arm assemblies and front arm assemblies to accommodate varying distances between tree rows.

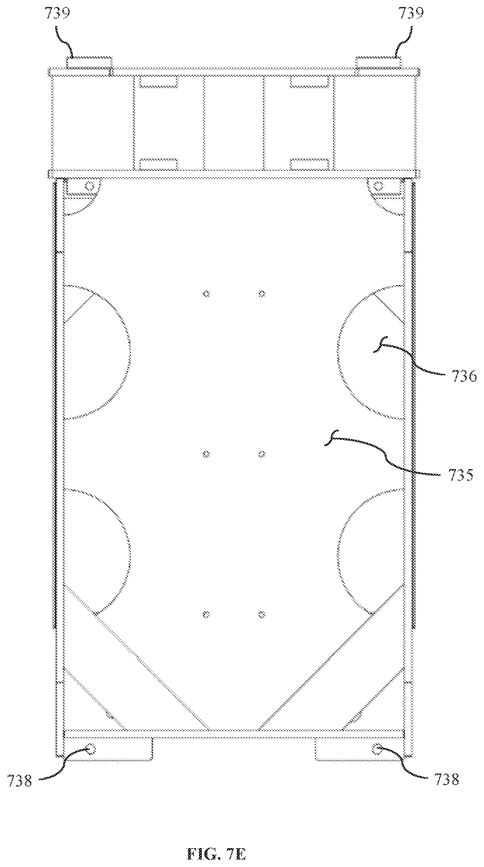

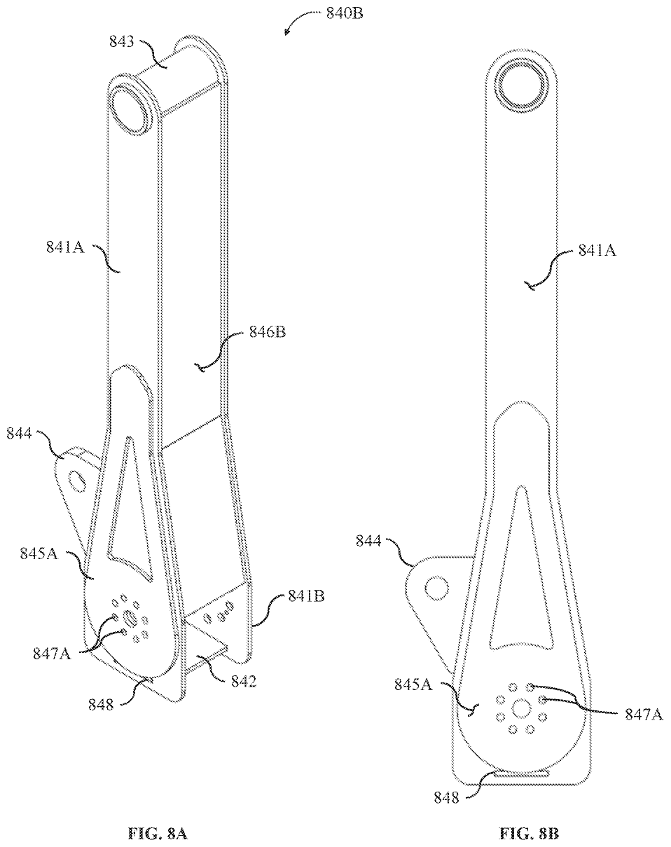

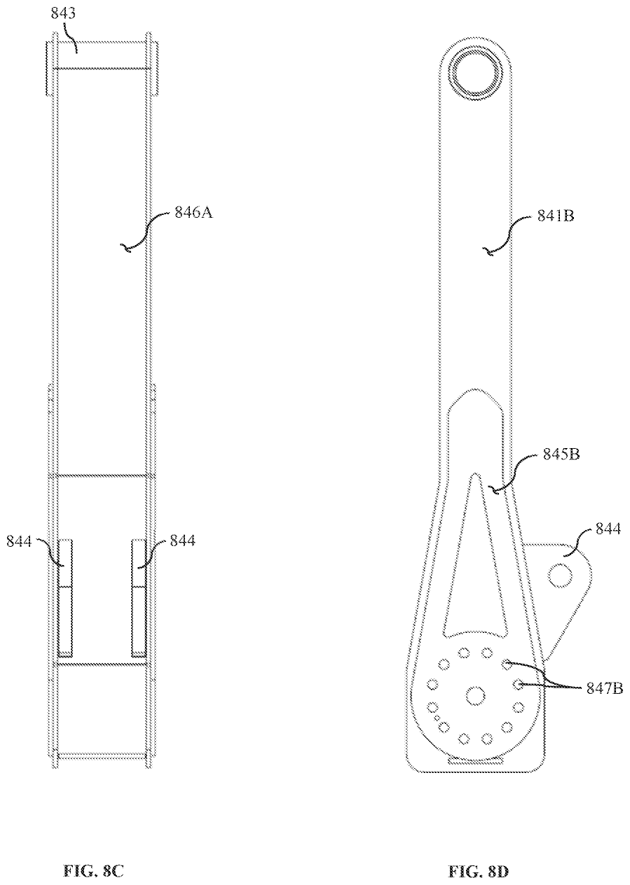

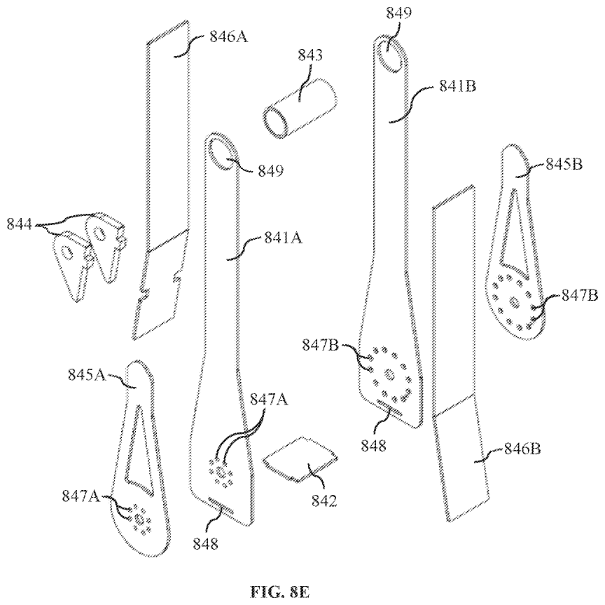

Referring now to FIGS. 8A-8E, therein is shown a right swing arm assembly 840B. A left swing arm assembly (not shown; see e.g., left swing arm assembly l40A of FIGS. 1A-1G, 280A of FIGS. 2A-2D, 380A of FIGS. 3A-3C and 480A of FIG. 4) and its components are similar, but generally, opposite hand. The description below of the right swing arm 840B is applicable to the left swing arm as well.

The right swing arm assembly 840B typically comprises two swing arm plates 841A, 841B, a swing plate connector 842, a swing tube 843, two swing arm ears 844, two actuator mounting plates 845A and 845B and two center plates 846A and 846B.

The swing arm plate 841A typically comprises a plurality of actuator holes 847A at or near one end, a slot 848 near the plurality of holes, and a larger single hole 849 at the other end (as best seen in FIG. 8E). Similarly, swing arm plate 841B also comprises a plurality of actuator holes 847B, a slot 848 near the plurality of holes, and a larger single hole 849 at the other end. The number, size, and configuration of actuator holes 847B of swing arm plate 841B may be different than the number, size, and configuration of the actuator holes 847A of swing arm plate of 841A. Actuator mounting plate 845A has a plurality of actuator holes 847A that are of the same number, size, and configuration of the actuator holes 847A of swing arm plate 841A. Similarly, actuator mounting plate 845B has a plurality of actuator holes 847B that are of the same number, size, and configuration of the actuator holes 847B of swing arm plate 841B.

The swing plate connector 842 fits into slots 848 and connects the two swing arm plates 841A, 841B. The swing plate connector 842 may be attached and/or connected to the swing arm plates 841A, 841B by welding, tack welding, brazing, soldering or other conventional means. In other embodiments, the swing plate connector 842 may snugly fit into the slots 848 and no further connection may be required.

Swing tube 843 fits through the larger holes 849 at the opposite end of the swing arm plates 841A, 841B, and may be attached and/or connected to swing arm plates 841A, 841B by welding, tack welding, brazing, soldering, or other convention means. Alternatively, swing tube 843 may snugly fit through holes 849 and no further connection may be required.

The center plates 846A, 846B fit between swing arm plates 841A, 841B to add strength and reinforcement to the swing arm 840B and may be attached and/or connected to the swing arm plates, 841A and 841B by welding, tack welding, brazing, soldering, etc. The swing arm ears 844 serve as an attachment point for a swing arm cylinder (described below) and, likewise, may be attached and/or connected to center plate 846A by the conventional means described above.

The right swing arm assembly 840B may be operably connected to the lift carriage assembly (see e.g., lift carriage assembly 130 of FIG. 1A, 230 of FIG. 2A, 330 of FIG. 3A and 430 of FIG. 4) by a swing arm pin (not shown; see e.g., swing arm pin 188 of FIG. 1G). The swing arm pin is inserted through holes 849 of swing arm plates 841A, 841B and into a bushing (not shown; see e.g., bushing 739 of FIGS. 7A-7E) to operably attach the swing arm assembly 840B to the lift carriage assembly. In some embodiments, the swing arm pin may be secured in place by a cotter pin or other standard mechanical fastener.

The actuator mounting plates 845A and 845B may be attached and/or connected to, respectively, the swing arm plates 841A and 841B (e.g., by welding, tack welding, brazing, soldering, etc.) The actuator mounting plate 845A in conjunction with the swing arm plate 841A, is utilized to operably attach the right swing arm assembly 840B to the front actuator (not shown, see e.g., front actuator 181 of FIG. 1G, 281 of FIGS. 2A-2B, 381 of FIG. 3A and 481 of FIG. 4). The actuator mounting plate 845B in conjunction with the swing arm plate 841B is utilized to operably attached the right swing arm assembly 840B to the rear actuator (not shown, see e.g., rear actuator 182 of FIG. 1G, 282 of FIGS. 2A & 2D and 382 of FIG. 3A). The front and rear actuators may be attached may be attached and/or connected to swing arm 840B via, respectively, holes 847A, 847B using bolts, nuts, washers, screws, pins, or other conventional means.

The swing arm ears 844 may be utilized to operably attach the right swing arm assembly 840B to a swing arm cylinder (not shown, see e.g., swing arm cylinder 185 of FIGS. 1B & 1E, 285 of FIGS. 2A-2B, and 385 of FIGS. 3A-3B) via a swing cylinder upper pin (not shown; see e.g., swing cylinder upper pin 187 of FIG. 1E, 287 of FIGS. 2A-2B, and 387 of FIGS. 3A-3B; see also swing arm ears 144 of FIG. 1B). The swing arm cylinder operates to rotate the swing arm 840B from 0 degrees to 90 degrees and back. The swing arm cylinder may also have an associated counterbalance valve to manage pressures and help prevent uncontrolled or uninitiated movement the swing arm.

Generally, the swing arms may comprise a variety of plates, angles, tubing, etc., and its various components may comprise, carbon steel, alloy steel, stainless steel, aluminum, tool steel, and or other types of metals.

Lower Arm Assemblies

Generally, the lower arm assemblies, which comprise one or more saw blades, are attached to the swing arms via a rotary actuator and may operate anywhere from 90 degrees to 225 degrees to skirt or hedge tree rows.

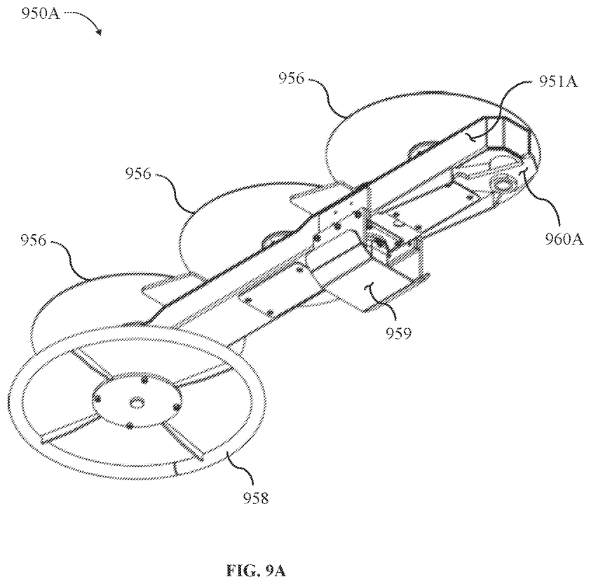

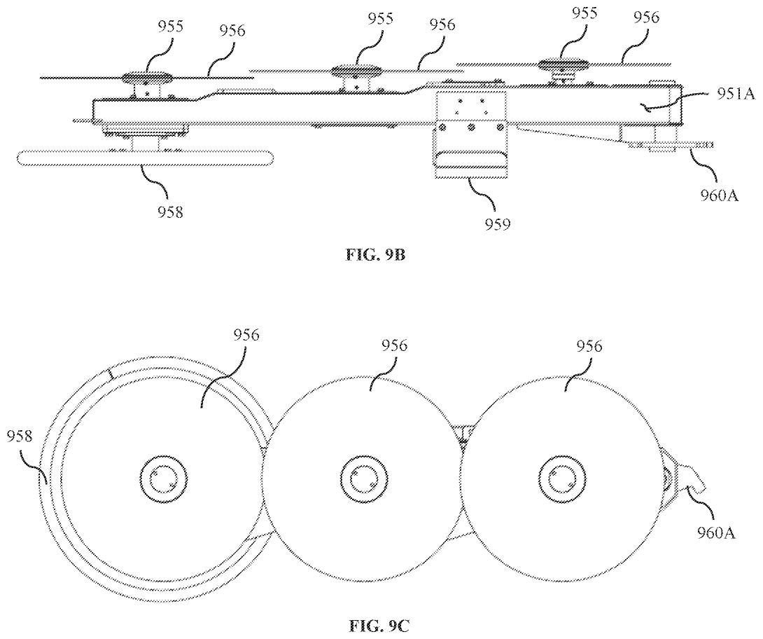

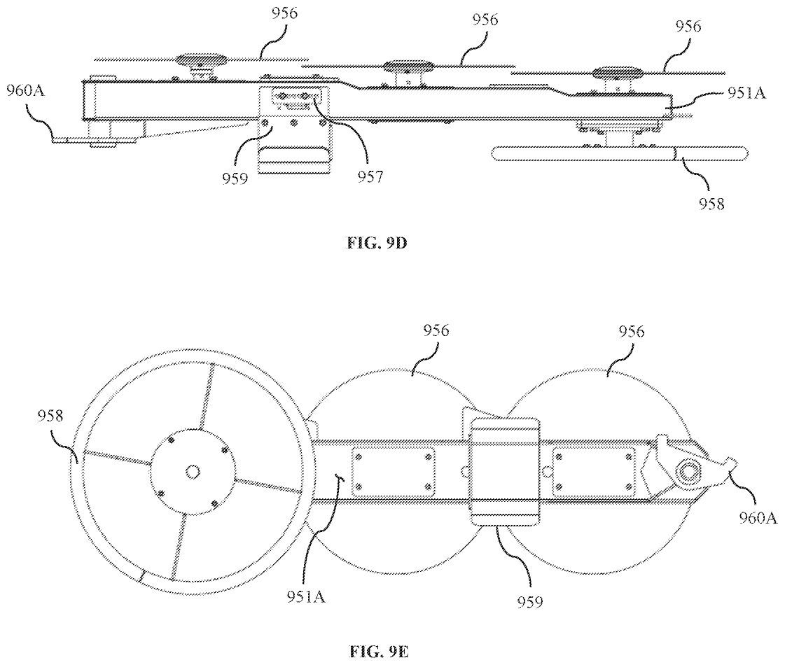

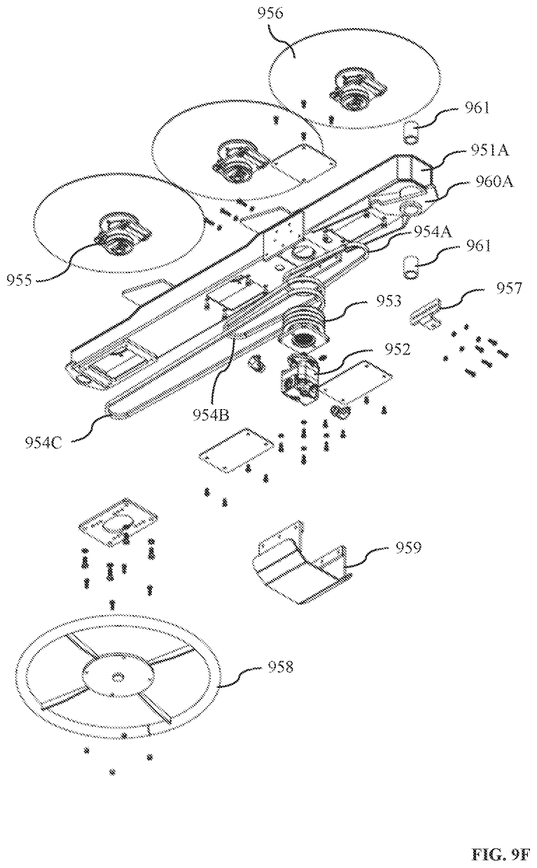

Referring now to FIGS. 9A-9F, therein is shown a left lower arm assembly 950A. A right lower arm assembly (not shown; see e.g., right lower arm assembly 150B of FIGS. 1A-1G; 250B of FIGS. 2A-2D, 350 of FIGS. 3A-3C and 450A of FIG. 4) and its components are similar, but generally, opposite hand. The description below of the left lower arm assembly 950A is also applicable to the right lower arm assembly.

Typically, the left lower arm assembly 950A comprises a left lower arm 951A having a lower arm bracket 960, a motor 952, a saw drive/pulley 953, belts 954A, 954B, 954C, blade drives 955, saw blades 956, a shock mount 957, a tree guard 958 and a saw beam skid 959.

The left lower arm 951A is operably attached and/or connected to a pivot (not shown; see e.g., pivot 184A of FIGS. 1A & 1F), which is connected to the rear actuator (not shown; see rear actuator 182 of FIGS. 1A & 1F, and 282 of FIGS. 2A & 2D). The attachment and/or connection of the left lower arm 951A to the pivot may be made utilizing the lower arm bracket 960A (which, in some embodiments may comprise one or more bushings 961) and one or more of a rod, shaft, pin and cotter pin (not shown).

The rear actuator rotates the left lower arm assembly 950A from approximately 90 degrees (approximately horizontal) to approximately 225 degrees and back again. When at approximately 90 degrees the lower arm assembly 950A skirts one side of a row of trees, and when between approximately 135 and 225 degrees the left lower arm assembly 950A hedges one side of a row of trees.

The rear actuator is also connected to the left swing arm (not shown; see e.g., left swing arm 140A of FIGS. 1A-1G, 240A of FIGS. 2A-2D, 340A of FIGS. 3A-3C and 440A of FIG. 4). The left swing arm 950A may be rotated (as described above) to extend and/or retract the left lower arm assembly 951A (in conjunction with the left front arm assembly described below). As the left swing arm rotates, the rear actuator may also rotate the left lower arm assembly 950A, including the left lower arm 951A, thereby, positioning the left lower arm assembly 950A and left lower arm 951A anywhere from approximately 90 degrees to approximately 225 degrees.

The motor 952 drives the saw drive shaft/pulley 953. In typical embodiments and as shown in FIGS. 9A-9E, the saw drive/pulley comprises three grooves, one groove for each of belts 954A, 954B and 954C, which correspondence to three blade drives 955, one for each of the three saw blades 956. However, in alternate embodiments, the number of saw blades of the left lower arm assembly 950A may vary from two to six, and the number of grooves in the saw drive/pulley and blade drives will vary accordingly. The motor may be a hydraulic, pneumatic or electric motor.

The shock mount 957 is utilized to connect and/or attach one end of a shock absorber (not shown; see e.g., shock absorber 183 of FIG. 1F) to the left lower arm 951A. The other end of the shock absorber is connected to the pivot (see e.g., pivot 184A of FIGS. 1A & 1F). The shock absorber serves to absorb forces that may be applied to the left lower arm assembly 950A during a hedging or skirting operation. Thus, the shock absorber may serve to prevent recoil of “kick-back” of the left lower arm assembly 950A during such operation. The shock absorber shown inf FIGS. 9A-9F is a coilover shock absorber (a coil spring/shock combination. However, the shock absorber may be of any type that appropriately absorbs the forces applied to the lower arm assembly 950A during operation.

The beam skid 955 protects the motor and saw drive/pulley from debris or objects on the ground, and the tree guard 958 acts as a “bumper” to protect the trunks of trees from contact with saw blades 956.

Generally, the lower arm assemblies may comprise a variety of plates, angles, channels, tubing, etc., and its various components may comprise, carbon steel, alloy steel, stainless steel, aluminum, tool steel, and/or other types of metals and/or plastics.

The saw blades may be made of steel, high carbon steel, high-speed steel, and may be hardened, carbide or tungsten tipped.

Front Arm Assemblies

Generally, the front arm assemblies, which comprise one or more saw blades, are attached to the swing arms via a rotary actuator and may operate anywhere from minus 45 degrees to plus 75 degrees to hedge tree rows.

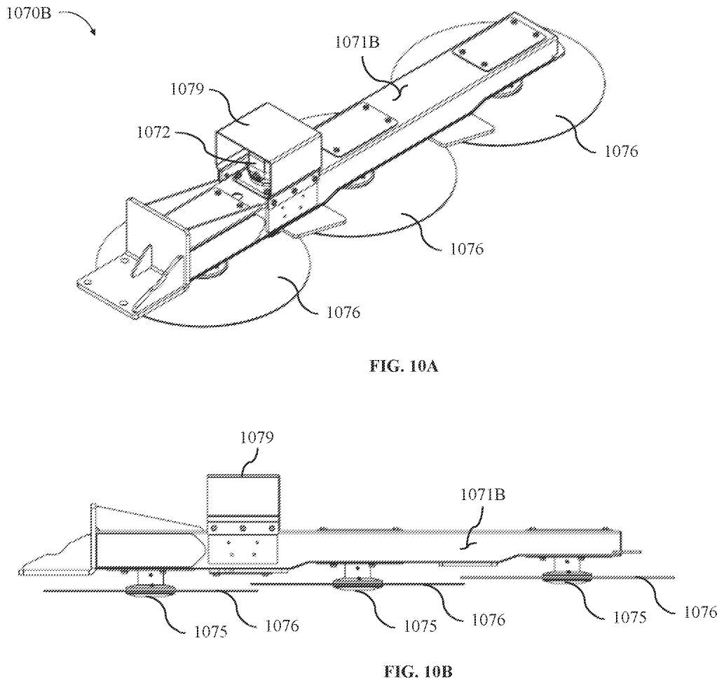

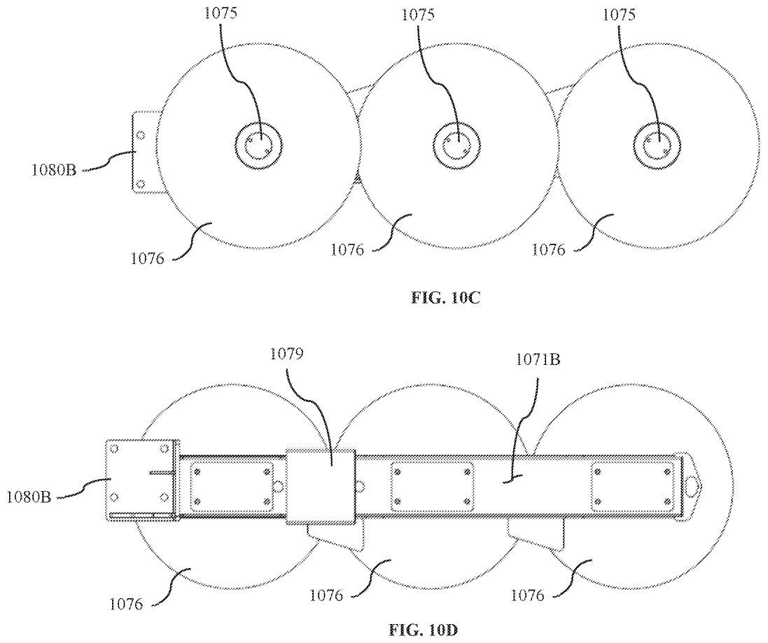

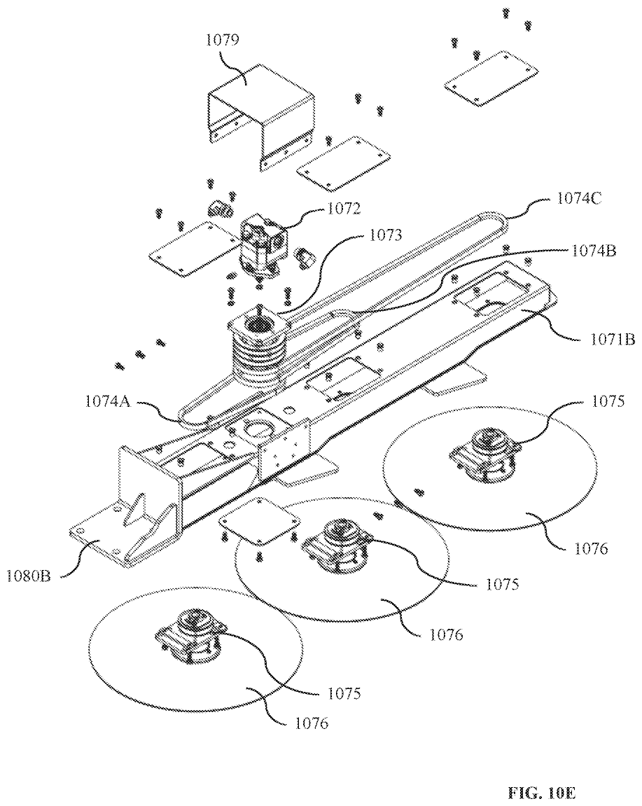

Referring now to FIGS. 10A-10E, therein is shown a right front saw arm assembly 1070B. A left front arm assembly (not shown; see e.g., left front arm assembly 170A of FIGS. 1A-1G; 270A of FIGS. 2A-2D, 370A of FIGS. 3A-3C and 470A of FIG. 4) and its components are similar, but generally, opposite hand. The description below of the right front arm assembly 1070B is also applicable to the left front arm assembly.

Typically, the right front arm assembly 1070B comprises a right front arm 1071B comprising a mounting bracket 1080B, a motor 1072, a saw drive/pulley 1073, belts 1074A, 1074B, 1074C, blade drives 1076, and a motor guard 1079.

The right front arm 1071B attaches and/or connects to a front actuator (not shown; see e.g., front actuator 181 of FIGS. 1A & 1F) via the mounting bracket 1080A. The attachment may be made using conventional fasteners (e.g., screws, bolts, nuts, washers, lock washers, etc.)

The front actuator rotates the right front arm assembly 1070B to position the right front arm assembly anywhere from approximately minus 45 degrees (counterclockwise 45 degrees from vertical) to approximately plus 75 degrees (clockwise 75 degrees from vertical). The front actuator is also attached and/or connected to the right swing arm (not shown; see e.g., right swing arm 140B of FIGS. 1A-1G, 240B of FIGS. 2A-2D, 340B of FIGS. 3A-3C and 440B of FIG. 4). The right swing arm may be rotated (similarly to the left swing arm as described above) to extend and/or retract the right front arm assembly 1070B in conjunction with the right lower arm assembly described above. As the right swing arm rotates, the front actuator may also rotate the right front arm assembly 1070B, including the right front arm 1071B, thereby, positioning the right front arm assembly 1070B anywhere from approximately minus 45 degrees to approximately plus 75 degrees.

The motor 1072 drives the saw drive shaft/pulley 1073. In typical embodiments and as shown in FIGS. 10A-10E, the saw drive/pulley comprises three grooves, one groove for each of belts 1074A, 1074B and 1074C, which correspondence to the three blade drives 1075, one for each of the three saw blades 956. However, in alternate embodiments, the number of saw blades of the right front arm assembly 1070B may vary from two to six, and the number of grooves in the saw drive/pulley and blade drives will vary accordingly. The motor may be a hydraulic, pneumatic or electric motor.

The motor guard 1079 protects the motor 1072 and saw drive/pulley 1073 from damage due to debris or obstructions that may exist in a row of trees.

Generally, the lower arm assemblies may comprise a variety of plates, angles, channels, tubing, etc., and its various components may comprise, carbon steel, alloy steel, stainless steel, aluminum, tool steel, and/or other types of metals and/or plastics.

Exemplary Methods of Using a Dual Arm Mechanical Pruning Apparatus

In an exemplary embodiment, a method of hedging, topping and/or skirting rows of trees using a dual arm mechanical pruning apparatus is disclosed. FIG. 12 illustrates an exemplary sequence of steps that facilitate hedging and/or skirting two adjacent rows of trees simultaneously or nearly simultaneously.

At step 1201 the dual arm mechanical pruning apparatus is attached to a transport vehicle (e.g., a tractor), by bolting (or other conventional means of connection/attachment) a vehicle mounting assembly (e.g., the vehicle mounting assembly 102 of FIGS. 1A-1G) to the transport vehicle. At step 1202, hydraulic, pneumatic hoses and/or electrical wires are connected from the transport vehicle to the dual arm mechanical pruning apparatus using a coupling manifold (e.g., see coupling manifold 506 of FIG. 5A-5D).

At step 1203, a lift carriage assembly (see e.g., lift carriage assembly 130 of FIGS. 1A-1G) is raised (e.g., using hydraulic, pneumatic and/or electronic controls on the transport vehicle) to an appropriate height for the hedging, toping and/or skiting operation to be performed. At step 1204, swing arms (see e.g., swing arms 140A, 140B of FIGS. 1A-1G) are positioned (e.g., using hydraulic, pneumatic and/or electronic controls on the transport vehicle) to between 0 degrees and 90 degrees, thereby extending or retracting the lower arm assemblies (see e.g., lower arm assemblies 150A, 150B of FIGS. 1A-1G) and the front arm assemblies (see e.g., front arm assemblies 170A, 170B of FIGS. 1A-1G) to the appropriate width for the distance between the rows of trees to be hedged, topped and/or skirted.

At step 1205, the lower arm assemblies are positioned (e.g., using hydraulic, pneumatic and/or electronic controls on the transport vehicle) to between 90 degrees and 225 degrees depending on the hedging, topping and/or skirting operation to be performed. At step 1206, the front arm assemblies are positioned (e.g., using hydraulic, pneumatic and/or electronic controls on the transport vehicle) to between minus 45 degrees and plus 75 degrees, depending on the hedging operation to be performed.

At step 1207, the motors (see e.g., motor 952 and 1072 of FIGS. 1A-1G) operating the saw blades (e.g., saw blades 956 and 1076 of FIGS. 1A-1G) are engaged (e.g., using hydraulic, pneumatic and/or electronic controls on the transport vehicle) to turn the saw blades. At step 1208, the transport vehicle is moved between adjacent rows of trees to hedge, top and/or skirt the adjacent rows of trees.

The steps of the method above may be performed in any order, and in some embodiments, not all steps are necessary for operation of the dual arm mechanical pruning apparatus.

The previous description of the disclosed embodiments is provided to enable any person skilled in the art to make or use the embodiments disclosed. Various modifications to these embodiments will be readily apparent to those skilled in the art, and the generic principles defined herein may be applied to other embodiments without departing from the spirit or scope of the disclosure. Thus, the present disclosure is not intended to be limited to the embodiments shown herein but is to be accorded the widest scope consistent with the principles and novel features disclosed herein.

What is claimed is:

1. A dual arm mechanical pruning apparatus comprising:
a mast assembly;
a lift carriage assembly;
two front arm assemblies, each front arm assembly comprising one or more saw blades;
two lower arm assemblies, each lower arm assembly comprising one or more saw blades;
two swing arms, each swing arm rotatably attached to the lift carriage assembly, one of the two front arm assemblies and one of the two lower arm assemblies;
where the two swing arms rotate, thereby extending or retracting the two front arm assemblies and the two lower arm assemblies relative to the lift carriage assembly; and
where the two front arm assemblies hedge and the two lower arm assemblies hedge or skirt trees.

2. The dual arm mechanical pruning apparatus of claim 1, where the mast assembly comprises:
an outside mast;
an inside mast; and
at least one mast cylinder operably attached to an outside mast and an inside mast where the at least one mast cylinder causes the inside mast to move substantially vertical relative to the outside mast, thereby raising or lowering the lift carriage, lower arm assemblies, front arm assemblies and swing arms relative to the outside mast.

3. The dual arm mechanical pruning apparatus of claim 1, further comprising two swing cylinders, each of the swing cylinders operably connected to the lift carriage and to one of the two swing arms, where each swing cylinder rotates one of the two swing arms, thereby extending or retracting the one of the two swing arms.

4. The dual arm mechanical pruning apparatus of claim 1, further comprising two lower arm rotary actuators, each of the lower arm rotary actuators operably connected to one of the two lower arm assemblies, where each of the two lower arm rotary actuators rotate the two lower arm assemblies.

5. The dual arm mechanical pruning apparatus of claim 4, further comprising two shock absorbers, each of the shock absorbers operably connected to one of the two lower arms and one of the two lower arm rotary actuators via a pivot, each of the two shock absorbers cushioning movement of one of the two lower arm assemblies.

6. The dual arm dual arm mechanical pruning apparatus of claim 1, further comprising two front arm rotary actuators, each of the front arm rotary actuators operably connected to one of the two front arm assemblies and configured to rotate the one of the two front arm assemblies.

7. The dual arm mechanical pruning apparatus of claim 1, where the one or more saw blades comprising each lower arm assembly are three saw blades.

8. The dual arm mechanical pruning apparatus of claim 1, where the one or more saw blades comprising each front arm assembly are three saw blades.

9. The mechanical pruning apparatus of claim 1, where the front arm assemblies can be positioned anywhere from approximately minus 45 degrees to approximately plus 45 degrees.

10. The mechanical pruning apparatus of claim 1, where the lower arm assemblies can be positioned anywhere from approximately 90 degrees to approximately 225 degrees.

11. A dual arm mechanical pruning apparatus comprising:
a vehicle mounting assembly;
a mast assembly;
a lift carriage assembly;
two front arm assemblies, each front arm assembly comprising three saw blades;
two lower arm assemblies, each lower arm assembly comprising three saw blades;
two swing arms, each swing arm rotatably attached to the lift carriage assembly, one of the two front arm assemblies and one of the two lower arm assemblies;
where the two swing arms rotate between approximately 0 degrees and approximately 90 degrees, thereby extending or retracting the two front arm assemblies and the two lower arm assemblies relative to the lift carriage assembly;
where the two front arm assemblies are positioned at approximately 0 degrees and the two lower arm assemblies are positioned at approximately 180 degrees; and
where one of the two front arm assemblies and one of the two lower arm assemblies skirts one side of a tree row and another one of the two front arm assemblies and another one of the two lower arm assemblies hedges an opposite side of a tree row simultaneously or nearly simultaneously.

12. The dual arm mechanical pruning apparatus of claim 11, where the mast assembly comprises:
an outside mast attached to the vehicle mounting assembly;
an inside mast; and
at least one mast cylinder operably attached to an outside mast and an inside mast where the at least one mast cylinder causes the inside mast to move substantially vertical relative to the outside mast, thereby raising or lowering the lift carriage, lower arm assemblies, front arm assemblies and swing arms relative to the outside mast.

13. The dual arm mechanical pruning apparatus of claim 12, where the mast assembly further comprises linear bearings operably attached to the outside mast, thereby allowing the inside mast to move easily relative to the outside mast.

14. The dual arm mechanical pruning apparatus of claim 11, where the vehicle mounting assembly is attached to a transport vehicle.

15. The dual arm mechanical pruning apparatus of claim 11, further comprising two swing cylinders, each of the swing cylinders operably connected to the lift carriage and to one of the two swing arms, where each swing cylinder rotates one of the two swing arms, thereby extending or retracting the two swing arms.

16. The dual arm mechanical pruning apparatus of claim 11, further comprising two lower arm rotary actuators, each of the lower arm rotary actuators operably connected to one of the two lower arm assemblies, where each of the two lower arm rotary actuators rotate the two lower arm assemblies.

17. The dual arm mechanical pruning apparatus of claim 16, further comprising two shock absorbers, each of the shock absorbers operably connected to one of the two lower arm rotary actuators and a pivot, each of the two shock absorbers configured to cushion movement of one of the two lower arm assemblies.

18. The dual arm mechanical pruning apparatus of claim 11, further comprising two front arm rotary actuators, each of the front arm rotary actuators operably connected to one of the two front arm assemblies and configured to rotate the one of the two front arm assemblies.

19. The dual arm mechanical pruning apparatus of claim 11, where the each of the two lower arm assemblies comprise a protector wheel.

20. A dual arm mechanical pruning apparatus comprising:
a vehicle mounting assembly;
a mast assembly;
a lift carriage assembly;
two front arm assemblies, each front arm assembly comprising three saw blades;
two lower arm assemblies, each lower arm assembly comprising three saw blades;
two swing arms, each swing arm rotatably attached to the lift carriage assembly, one of the two front arm assemblies and one of the two lower arm assemblies;
where the two swing arms rotate between approximately 0 degrees and approximately 90 degrees, thereby extending or retracting the two front arm assemblies and the two lower arm assemblies relative to the lift carriage assembly;
where the two front arm assemblies are positioned at approximately 0 degrees and the two lower arm assemblies are positioned at approximately 90 degrees; and
where one of the two front arm assemblies hedges and one of the two lower arm assemblies skirts one side of a tree row and another one of the two front arm assemblies hedges and another one of the two lower arm assemblies skirts an opposite side of a tree row simultaneously or nearly simultaneously.
